(19) United States
(12) Patent Application Publication
(10) Pub. No.: US 2011/0061601 A1
(43) Pub. Date: Mar. 17, 2011

(54) Method and apparatus for reduction of ammonia, carbon dioxide and pathogens in chicken houses

(75) Inventors: Rafael S. Correa, Salisbury, MD (US); Mark Anthony Dekich, Salisbury, MD (US); William D. Samson, Salisbury, MD (US); Erich Frederik Bevensee, Eden, MD (US)

(73) Assignee: AviHome LLC.

(21) Appl. No.: 12/923,084

(22) Filed: Aug. 31, 2010

Related U.S. Application Data
(63) Continuation-in-part of application No. 11/475,236, filed on Jun. 27, 2006.
(60) Provisional application No. 60/693,797, filed on Jun. 27, 2005.

(51) Int. Cl. A01K 31/18; A01K 1/00; F24F 7/007

(52) U.S. Cl. 119/437; 119/448

(57) ABSTRACT

A chicken or fowl grow out facility utilizes a ventilated floor assembly including a ventilated floor through which liquid and gas can flow, but which retains manure and other solids deposited thereon, and a bottom floor plenum underneath the ventilated floor. A liquid and vapor barrier sheet preferably covers the ground surface underneath the floor assembly which together insulate the high temperature of the grow-out facility from the heat sink effect of the lower temperature ground. Conventional tunnel ventilation of the chicken house through the ends of the house creates a negative pressure inside the house relative to the outside environment which is vented to the floor assembly plenum. As a result of this tunnel ventilation and negative pressure, moisture in the manure from urine and otherwise evaporates into the air in the growth chamber and floor assembly plenum to effectively keep dry the manure retained on the floor and reduce ammonia formation and pathogen growth.

### RELATED APPLICATIONS

This application is a continuation-in-part application of, and hereby claims priority to, co-pending U.S. application Ser. No. 11/475,236, filed Jun. 27, 2006, which claims the priority of provisional application Ser. No. 60/693,797, filed Jun. 27, 2005.

### BACKGROUND OF THE INVENTION

1. Field of Invention

The present invention relates generally to improvements in new and existing chicken house structures and methods of operation which reduce air-borne contaminants, such as ammonia (NH₃), methane (CH₄), carbon dioxide (CO₂) and hydrogen sulfide (H₂S), emissions and pathogens including, but not limited to, salmonella, E-coli, coccidiosis, other bacteria strains and fungus/mold development, while concurrently improving carbon dioxide removal, meat bird performance, chicken manure removal, chick brooding and overall chicken welfare during the growing process.

The present invention also relates to chicken house structures and methods in order to improve overall chicken production.

2. Background Information

The chicken growing industry is based on mass production and low margin in which production casualties or weight reduction that might be considered trivial in other commercial activities can be detrimental to production cost. The magnitude of the industry is evident from the fact that a typical chicken house (approximately 40 to 60 feet×500 to 600 feet) will house from about 20,000 to about 45,000 birds per flock. At harvest time, a typical commercial chicken house can have a density of 0.8 square feet per chicken or 7.5 lbs/square foot. Each bird will have consumed an average of 1.8 lbs. of feed per pound of chicken and an average of 2.25 gallons of water per pound of chicken by harvest time. Forty percent of the feed and water is consumed during the last week of growth. Broilers are grown to an average of 5.5 lbs. and roasters to an average of 7.25 lbs. The total amount of manure deposited on the floor bedding during each growth cycle is approximately 150,000 lbs. The total amount of excreted water is approximately 50,000 gallons, which makes it impossible to achieve and/or maintain bedding dryness under existing chicken house conditions.

Wet manure and saturated bedding, along with the massive animal heat generated by so many birds, results in perfect environmental conditions for bacteria and fungus development. Unfortunately, the widespread use of evaporative coolers for reducing the temperature can be counterproductive in that it results in high humidity, which is also conducive to ammonia and pathogen production. As the bacteria feeds on the manure and multiplies, it produces large amounts of ammonia gas, as well as methane gas. Uric acid breakdown accounts for 60% to 75% of the ammonia and CO₂ emissions. The use of ventilation systems for removing ammonia and other gasses is not a satisfactory solution since such use can have undesirable results such as the introduction of cold air into the facility during cold weather with minimal ventilation.

One of the main problems resulting from high levels of ammonia in the chicken house is a wider variation in the uniformity of the flock. The percentage of small chickens can be as high as ten percent (10%) or more, and such birds cannot recover from growth deprivation early in their life cycle due to the fact that they cannot compete for or reach the water and feeder systems, which are at an elevation to accommodate normal-sized birds in the flock. Another problem resulting from high ammonia levels is increased susceptibility to disease producing pathogens including, but not limited to, E-coli infection, infectious bronchitis, and New Castle Disease.

Research has demonstrated that ammonia levels at or above 50 ppm (parts per million) inhibit bird growth, creating a degree of weight loss in all of the birds, not just the stunted chickens. Such weight loss can be as much as a half-pound per bird during a typical seven-week growth period. In fact, ammonia levels as low as 25 ppm have been shown to diminish bird growth. High ammonia levels also create physical defects such as blindness in the birds. Needless to say, a reduction in the number and size of marketable birds in a flock can be significantly detrimental to production cost. Moreover, the financial damage to the producer resultant from the loss of mature birds goes beyond the lost sales due to the previously incurred cost of feeding the chickens.

As stated previously, decomposition of the uric acid contributes 60% to 75% of the ammonia emissions in the chicken house, and large amounts of growth-inhibiting carbon dioxide are also produced. The carbon dioxide is 50% heavier than air and collects in a layer which remains near the floor of the facility affecting the bird level environment. Moreover, the carbon dioxide is difficult to remove due to the fact that the exhaust ports in conventional facilities are typically located in elevated positions well above the carbon dioxide layer. Also, the density of the chickens in the chicken house reduces the ability to effect flushing of the carbon dioxide from the facility since the chickens occupy the same space on the floor of the facility as the carbon dioxide. The carbon dioxide gas concentration is also greater during the last week of growth because the chickens consume approximately 40% of their total feed and water requirements during this time period as they are achieving their genetic potential for growth. The size of the chickens as well as their high concentration per sq. ft. of floor space consequently makes it very difficult to properly flush carbon dioxide and any other gas trapped between and under the chickens.

At chicken harvesting collection time the bedding is saturated with wet manure, making it the perfect environment for high ammonia levels, salmonella, E-coli, coccidiosis, multiple bacteria strains, fungus/mold and other pathogens to develop and multiply. This problem is exasperated at collection time due to the fact that the feed and water lines are lifted to a high elevation out of reach of the chickens in preparation for the collection procedure. The chickens consequently then naturally feed from the contaminated bedding with the result frequently being significant contamination of the chickens by potential food borne pathogens, i.e., salmonella, E-coli, and campylobacter.

Detection of ammonia would obviously permit steps to be taken in an effort to reduce the ammonia level; however, such steps are frequently not taken because many producers are unaware of low, but harmful, ammonia levels in their facilities. Such unawareness is due to the fact that the human nose loses olfactory sensitivity to ammonia after repeated or long-term exposure and the growers become incapable of detecting ammonia levels of 50 ppm or lower due to such deterioration. Controlled experiments have shown that 50 ppm ammonia will cause a half-pound weight loss in a typical seven-week broiler growth period.

Hazards and additional grower expense arising from ammonia and other air-borne contaminants present in poultry growth facilities are not limited to poultry since such contaminants also create substantial health hazards for workers in such facilities including coughing, eye-irritation, dyspnea, headaches, fatigue and behavioral changes resulting in lost work-days and increased health and insurance costs to the producer.

### 3. DESCRIPTION OF PRIOR TECHNOLOGY

It has been the practice of the poultry industry to require producers to meet certain minimal chicken house conditions. These requirements include providing a compacted dirt floor. Over this dirt floor, three (3) inches of bedding (wood chips, sawdust, straw, chopped cardboard, etc., sometimes referred to as “litter”) are required. The intended purpose of this bedding litter is to provide insulation from the ground and to have the capacity to absorb moisture from the chicken manure.

The litter requirement for a typical chicken house is a further factor contributing to poor conditions adjacent the floor of the chicken house. The temperature of the ground serving as the floor underneath the bedding litter is usually at about 56 degrees Fahrenheit which creates a heat sink effect in the chicken house during warm weather. This heat sink effect causes moisture in the air in the house to go to the ground in warm weather. Further, during cold weather, when the chicken house is heated, moisture in the ground can rise up into the bedding litter. These factors exacerbate the problem of moisture in the bedding litter and a resultant increase in the chemical reactions which produce ammonia, methane and other pollutant gases.

Another requirement for producers is to provide ventilation capable of changing the total air in the chicken house once per minute during warm weather (tunnel ventilation) and to provide minimum ventilation capable of changing the total air by cross ventilation every 6 to 8 minutes in cold weather, in addition to maintaining a required temperature, water and forage. Such ventilation requirements can be energy inefficient.

Conventional chicken house design and ventilation technology in use today consist of tunnel ventilation in warm weather and minimal cross ventilation in cold weather, neither procedure conforming with EPA ammonia emission and OSHA human exposure standards. The humidity retained in the litter, along with the undigested feed and uric acid found in chicken manure, creates a uniquely productive environment for the development of ammonia, carbon dioxide, hydrogen sulfide, methane, bacteria and fungus/mold. The present invention is directed to apparatus and methods for alleviating the foregoing problems.

Tunnel or laminar ventilation of conventional chicken houses in warm weather is provided by a series of exhaust fans located at one end of the elongated chicken house that pulls air through the length of the house (exhaust). On the opposite end of the elongated chicken house, ambient air is pulled through negative pressure flap openings and/or cold water saturated cooling pads (intake) that cool and saturate the air which then travels along the length of the chicken house and is exhausted by the exhaust fans.

Although the tunnel ventilation system of water-saturated air will create the sensation of lower temperatures in most animals, it is not effective for cooling chickens due to the fact that they do not perspire. Moreover, their feathers insulate their skin so that the effects of water-saturated airflow can actually be adverse to them because the chickens' natural method of cooling is by panting. Panting is pulling ambient temperature air into the chickens' lungs and airsacs to absorb body heat and expel this warmer air. Their ability to effectively cool themselves by panting is greatly hampered when the air is already saturated with moisture prior to inhalation. This condition forces the chickens to pant for prolonged periods of time during which they are burning calories due to breast muscular activity and not eating or drinking, thereby negatively affecting their growth.

The above-described tunnel ventilation when using water-saturated air can also suffer from the inability of the moisture-saturated air to absorb additional moisture from the bedding. As the bedding becomes saturated with water and manure, and with the lack of natural light, substantial heat is generated by the bedding thus raising the temperature surrounding the chickens. An environment is thus created for multiplying bacteria and fungus/molds. Moreover, the water-saturated air enhances uric acid decomposition and resultant carbon dioxide and ammonia, as well as methane, emissions. The additional water in the saturated air can also increase bacterial production of ammonia in the litter.

Another problem for the conventional chicken house is that the tunnel ventilation can cause the chickens to migrate toward the incoming air seeking fresh oxygenated air, packing themselves in tightly at the air intake end, and causing injuries and bruises. This migration also increases the concentration of manure in this area and also reduces the area for natural water absorption by the bedding, since the chickens defecate in a reduced floor area, which prevents the bedding from evaporating the liquid and precludes bedding drying.

An alternative to exhausting the noxious gases generated in chicken houses to the surrounding environment is to use air-scrubbers, which are typically installed at the air exhaust end of the chicken house for removing ammonia and other gas emissions. Although proven in other industries, this technology is very costly and requires high maintenance and substantial energy consumption. Moreover, the air-scrubbers have no effect on salmonella, E-coli, coccidiosis, multiple bacteria strains and fungus/mold contamination, and the scrubbers provide no advantages which improve the chickens' welfare.

Chicken collection for marketing in today's chicken houses is done manually, or with mechanized catching equipment to a small degree. The manual method consists of several workers (chicken catchers) that chase, catch and hold the birds by their feet. By placing one chicken leg between each finger until they have a hand-full, the chickens are then placed in a cage at a prescribed number. When the cage is full, it is picked up by a forklift and loaded onto a truck for transportation to the processing plant. The mechanized method consists of a self-propelled or motorized vehicle, equipped with a conveyor to carry the chickens out in order to later manually place them in the cage. At the entrance of the conveyor there are two inwardly rotating wheels/brushes; some with rubber fingers, others use plastic materials to pull the chicken onto the conveyor, while simultaneously workers are corralling the chickens toward the conveyor entrance of the machine.

The present collection procedures are expensive and create several undesirable problems. In the case of the manual system, labor is a major issue due to both its availability and cost. The process is stressful for the chickens, with bones being broken and the chickens bruised, thereby reducing product value. The mechanized method requires expensive equipment and also stresses and injures too large a percentage of the chickens. Another substantial problem arises from the fact that the forklift vehicles and the catching machine both go from chicken house to chicken house, thus resulting in the spread of pathogens and diseases among the chicken farms. Bio-security of people and equipment is a serious problem.

During the chicks first two weeks, the environment as well as the temperature is important in order to achieve full genetic potential. Improper brooding is one of the most common causes of stress in poultry production.

There is a large body of information available with the recommended brooding temperatures during this critical time. All these recommendations are made with the assumption that the starting point is clean dry bedding. The bedding materials used today are absolvent and not able to dry during chicken house down time (typically 13 days) as the manure blocks any ventilation that would be necessary to accomplish this process. As the chicken house is prepared for brooding the temperature is raised above 95° F. Not only is this extremely energy inefficient, but it causes the evaporation of the urine retained by the bedding of the previous flock. This chemical reaction produces large amounts of ammonia gas as well as carbon dioxide. Although the house is at 95° F., the evaporation at floor level where the baby chicks are placed creates a cooling effect. The CO, gases are 50% heavier than air. This creates a very poor environment for the baby chicks as their needs are warmth and fresh or properly oxygenated air.

### SUMMARY OF THE INVENTION

In order to overcome the technical problems of existing chicken houses and the established inefficient operating procedures currently being followed, the present invention provides apparatus and methods which avoid or minimize the use of bedding and which provide for better control of ventilation, temperature and humidity. The apparatus and methods of the present invention act to remove the water and moisture from the manure deposited on the floor so as to reduce ammonia formation, and perhaps' methane formation, as well as reduce salmonella, E-coli, coccidiosis, multiple bacteria strains and fungus/mold growth. The manure and chicken house floor are kept dry. If air-borne contaminants are generated, they are effectively removed from the chicken house and exhausted to the outside. The present invention also improves chicken genetic performance potential, uniformity and provides improved harvesting of mature birds at collection time.

The present invention can be effected in either a new chicken house or retrofitted into any existing chicken house and both active and passive systems are included. The chicken house of this invention has a poultry growth or grow out chamber enclosed by a ceiling, a front wall, a rear wall, a right side wall, a left side wall and a multiple component floor assembly which provides a ventilated floor assembly. The floor assembly has a ventilated floor component, such as a geotextile carpet or flat molded plastic sections with small ventilation openings set side-by-side, through which air and liquid (moisture) can easily flow but retains substantially all of the solids on its upper surface, and a modular ventilated supporting structure. The ventilated floor assembly extends over the entire growth chamber for supporting the chickens thereon.

Spaced below the ventilated floor assembly is a bottom component made of water and vapor impermeable material, such as polyethylene sheeting or the like, which prevents any water or other liquid or gasses from escaping and/or entering into the ground of the chicken house. It has been found that the combined floor assembly and polyethylene sheeting of the present invention serve as an insulation barrier between the chicken growth chamber and the ground, thus reducing the effect of the ground acting as a heat sink in the chicken house in warm weather and a source of moisture in cold weather.

Spaced between the ventilated floor and the impermeable barrier is a modular ventilated supporting structure made up of a plurality of side-by-side ventilated plastic modules and which support the ventilated floor. The plastic modules together with the impermeable membrane form a bottom floor plenum, either closed or open, underneath the lower surface of the geotextile carpet (or other ventilated floor component). In an active system, the floor plenum can be maintained at sub-atmospheric pressure by one or more exhaust fans which create a pressure differential between the growth chamber and the floor plenum that is conducive to downward air flow from the growth chamber through the geotextile carpet component or ventilated floor component and manure thereon and into the floor plenum. The exhaust fans then exhaust the air, moisture and airborne contaminants drawn into the floor plenum to the outside. Alternatively, it has been found according to a passive embodiment, that exhaust fans to exhaust the floor plenum and create a negative pressure in the floor plenum are not necessary to dry the manure retained on top of the floor assembly of the present invention or to substantially prohibit the production of ammonia gas in the chicken house, as will be described more fully hereinafter.

In one preferred embodiment, the impermeable bottom component which covers the ground of the chicken house and the side-by-side ventilated plastic modules which support the ventilated floor are combined into a unitary bottom floor module. Each bottom floor module includes a flat base component and a plurality of upstanding hollow support elements or spacers. The hollow support elements are preferably cone-shaped and are truncated at the top to provide a flat upwardly facing support surface with a circular opening at its center. The flat base component of the bottom floor modules is rectangular in plan shape, preferably square, and the unitary modules are preferably injection molded of suitable polymeric material. The side edges of each flat bottom component also include an interlocking element or elements so that when they are set side-by-side on the ground, the flat bottom components interlock together. Thus, the flat bottom components cover the ground surface of the chicken house. Further, as mentioned previously, a separate layer of waterproof material, such as polyethylene sheeting, is preferably placed over the ground surface and under the unitary bottom floor modules forming the plenum to fully retain moisture, darkling beetles, bacteria, mold and other substances below the floor structure.

In this preferred embodiment, the ventilated floor is made up of a plurality of ventilated modular floor sections each having the same rectangular size and shape, preferably square, as the flat base component of the bottom floor modules. Other polygonal shapes such as triangular, hexagonal, etc., that allow for interlocking of adjacent floor sections to form a solid floor could also be used. The rectangular ventilated floor sections are also injection molded of a suitable polymeric material and have numerous small holes to allow gas and moisture to pass therethrough but retain the manure and other solids on their upper surface. The ventilated floor sections also include cylindrical projections or bosses which extend downwardly from their lower surface and are sized to snap-fit or interlock into respective circular openings in the top of each hollow cone-shaped support element.

The small holes in the ventilated floor sections, which allow passage of gas and moisture therethrough but retain the manure and other solids thereon, can have any cross-sectional shape such as round, square, triangular, etc. and can be tapered or not tapered. In a preferred embodiment, the holes are in the shape of tapered slots. The slots are preferably about 0.020 inches to about 0.25 inches wide and about 0.125 inches to about 0.200 inches long, even up to about 1.0 inch in length.

It has been further found that the total area of the hole openings should comprise a minor portion of each floor section area. The hole opening area can comprise between about 2% and about 25% of the floor section area, preferably between about 3% and about 12%, and most preferably between about 4% and about 6%.

When assembling the floor assembly in this embodiment, the ventilated floor sections are preferably staggered with respect to the bottom modules. The staggered relationship produces an overall ventilated floor assembly which is an interlocked unitary structure over the entire floor surface of the chicken house, except adjacent the side edges due to the staggered relationship of the floor sections and bottom floor modules, which can be trimmed as necessary. When so assembled, the ventilated floor assembly of the present invention is sufficiently strong and rigid to support vehicular traffic typically used in a chicken house.

In one embodiment, the snap-fit configuration, previously described between projections or bosses of the ventilated floor sections and the top openings of the support elements, is preferably provided by laterally positioned locking teeth on the outer surface of the cylindrical projections or bosses. When the bosses are fully inserted into the hollow cone-shaped support elements or spacers, these teeth engage flanged ledges formed inside the tops of the support elements or spacers to interlock the floor sections to the bottom modules.

When assembled together, the side-by-side ventilated floor sections make up the ventilated floor. The side-by-side bottom modules, with their interlocked flat base components covering the ground surface and the cone-shaped spacers supporting the floor sections, form the bottom plenum, either closed or open, underneath the ventilated floor. As mentioned previously, the ventilated floor assembly acts in combination with the polyethylene sheeting barrier as a heat insulator for the chicken house to insulate the higher temperature growth chamber (about 90°-98° F.) from the much lower ground temperature (about 56° F.). Because the floor assembly serves to insulate the growing chamber from the cooling effect of the ground, young chicks placed on the floor assembly do not huddle but start eating and drinking immediately which facilitates their growth from the start.

When installing the ventilated floor assembly in a passive system for the chicken house, either new or as a retrofit, the floor assembly is preferably divided along a center line that runs the length of the house, with each side sloping downwardly from the center line toward the sides of the house. The sides of the house are provided with a plurality of drains. After the chicks have grown to the harvesting stage and have been removed from the house, the slope of the floor and the interconnected construction of the floor plenum assists in washing down the floor and collecting and pumping off of the cleaning water so that the underlying ground is not saturated with the run-off when preparing the house for the next flock of chicks.

Further, if the existing or new chicken house is constructed over soft soil, it may be desirable to install a layer of crushed stone or other compactable material underneath the floor assembly of the present invention. Such substrate layer ensures that the soft soil will not impede use of conventional vehicular traffic in the chicken house. Also, if the ventilated floor assembly of the present invention is to be utilized in an existing or new chicken house with a concrete floor, rather than directly on ground or soil, it is still preferable to utilize the polyethylene barrier film in order to achieve the full heat and moisture insulator effect of the present invention since concrete has a high moisture content which could be drawn into the growth chamber.

In an active system, one source of air flow into the growth chamber when the chicken house is occupied can be created by a plurality of power-driven ambient air injection fans mounted in the attic plenum space of the chicken house. The fans have an air inlet port communicating with the attic plenum and an air discharge port communicating with the floor plenum. Fresh air can enter the attic plenum space through ambient air inflow permitting openings in the wide overhanging eaves of the chicken house. Ambient air is consequently pulled into the open attic plenum and discharged into the floor plenum where it is dispersed and rises up through the ventilated floor into the growth chamber.

A second source of air flow into the growth chamber in an active system according to the present invention is provided by a plurality of energy-saving indirect evaporative coolers and air blowers mounted along the side walls of the chicken house. The air blowers direct ambient or cooled air into the growth chamber which imparts a positive pressure to the growth chamber creating a pressure differential between the growth chamber and the floor plenum. This pressure differential can cause air, carbon dioxide, ammonia, methane, hydrogen sulfide, and moisture in the growth chamber consequently to flow downwardly through the geotextile carpet or other ventilated floor component into the floor plenum, leaving the dry manure retained on top of the geotextile carpet or other floor component. The air along with reduced quantities of carbon dioxide, ammonia, methane, hydrogen sulfide, and moisture in the floor plenum are then exhausted and discharged externally of the chicken house. By so doing, the humidity in the growth chamber is lowered and the ammonia and other air-borne contaminants from the manure on the ventilated floor, as well as in the entire growth chamber, are reduced or eliminated.

Turning now to the passive system according to the present invention, air blowers and evaporative coolers are not used to force air through the floor and, in fact, no positive pressure differential is created between the growth chamber of the chicken house and the floor plenum. Rather, the floor plenum is vented at convenient locations to the growth chamber. In this passive embodiment, the only positively driven airflow into and out of the chicken house is the conventional tunnel ventilation air flow through the chicken house from one end to the other. This tunnel ventilation air flow through the ends of the house, typically generated by outwardly blowing exhaust fans at one end, and negative pressure flap openings, cold water cooling pads or other openings at the other end, as known in the art, creates a negative pressure inside the house relative to the outside environment. The plenum vents are preferably located along the sides of the chicken house and at various locations on the ventilated floor assembly, such as along a crown at the center line of the floor assembly at longitudinally spaced locations through the length of the chicken house. Due to the plenum vents, the negative pressure in the growth chamber is also transmitted to the floor plenum without the need for any additional air moving mechanism.

With the negative pressure in the floor plenum in contact with the underneath side of the manure retained on the floor sections through the small floor holes, and the negative pressure in the growth chamber in contact with the top side of the manure, the moisture in the manure continuously evaporates along both the top and the bottom surfaces of the retained manure. The ventilation air flow acts to exhaust the evaporated moisture from the chicken house to thus keep the manure “dry”. While not intending to be legally bound by a specific drying theory, it is believed that moisture in the manure is being continuously evaporated, and the manure dried, by a wicking action through both the top surface and the bottom surface of the manure.

High pH levels, above 7.0, in the chicken feces (manure) causes ammonia formulation and the presence of water in the manure causes the pH level to elevate. It has therefore been found that reducing the moisture or water content in the manure serves to reduce the production of ammonia. Specifically, it has been determined that the manure should be dried in accordance with the present invention to a moisture content of between about 20% and about 30% on a weight basis. By maintaining this low moisture content in the manure, the pH of the manure can be kept below about 7.0, and preferably between about 5.0 and about 6.0. By keeping the pH and the moisture content within these ranges, the formation of ammonia and methane gas is substantially reduced, and even eliminated, thus reducing a major factor inhibiting the growth of the chicks while at the same time reducing the growth of both mold and bacteria and eliminating noxious ammonia odor in the chicken house and surrounding environs.

While the present invention is intended to function well without the use of bedding, the feet of new chicks must be protected in those areas of the chicken house where increased amounts of moisture accumulate and can become acidic due to excess urine, such as around the water dispensing nozzles where the chicks congregate and both drink and urinate. In these areas, a thin layer of wood shavings or chips may be placed on the upper surface of the floor. Once the chicks have grown sufficiently to develop natural callouses on their feet, generally after about 2-3 weeks, the wood chips are no longer necessary.

According to an alternative embodiment also directed to protecting the feet of new and young chicks from the acidic effects of urine around the water dispensing nozzles, the top of the floor sections underneath the nozzles can preferably be provided with a grid material, such as high density polyethylene (HDPE) grid or polypropylene grid. The grid material is preferably placed in longitudinally extending layers to form a longitudinal “mound” extending underneath the length of the water line. The mound can have tapered sides to allow the chicks to walk up and down while, at the same time, provide for effective drainage of moisture away from the area immediately beneath the water dispensing nozzles. The grid material can be supported in the mound configuration by wood blocks or the like or can be injection molded into a self-supporting mound shape.

At harvest time, the chickens are gently urged by lights and/or sensory training and/or, in one embodiment, by power-driven movable pusher wall to position them without injury on a removal conveyor along one side of the facility for removing the chickens from the facility.

When the chicken house is ready for cleaning, the dry manure can simply be vacuumed up from the ventilated floor surface, pushed by power equipment onto an evacuating conveyor, or washed away into appropriate drains as described previously. The ventilated floor assembly is then washed down and disinfected as necessary. Any broken components of the floor assembly can be replaced due to the modular design.

It is, therefore, an object of the present invention to provide a new and improved chicken growth or grow out facility or chicken house which reduces the moisture in the chicken house and particularly from the manure, thus leaving the manure dry.

Another object of the present invention is to provide a new and improved chicken growth facility or chicken house which significantly reduces the quantity of ammonia formation and bacteria growth in the chicken house and also reduces the levels of ammonia and bacteria exhausted from the chicken house to the outside atmosphere.

A further object of the present invention is to provide a chicken growth facility or chicken house having improved moisture and temperature control capabilities for better chicken growth and overall health.

A still further object of the present invention is to provide a new and improved chicken growth facility or chicken house in which the level of ammonia generation and bacteria growth are substantially reduced to improve the health of the flock and enhance the overall weight and uniformity of the mature chickens.

Still another object of the present invention is to provide a chicken house in accordance with the preceding objects that includes an active ventilated floor system having a ventilated floor through which air and liquid can easily flow but which retains all solids on its upper surface, together with a bottom air plenum, either closed or open, underneath the floor to draw air and other gases and airborne contaminants from the growth chamber into the plenum while at the same time keeping dry any manure retained on the ventilated floor upper surface.

A still further object of the present invention is to provide a ventilated floor assembly which is made of molded plastic modular components that can be assembled in an interlocked rigid floor assembly, including a ventilated floor and a bottom air plenum below the ventilated floor which provides a continuous bottom wall to protect the ground surface of the chicken house.

Yet a further object of the present invention is to provide a chicken house in which the ground thereof is sealed off to prevent darkling beetles from coming up out of the ground to feed on the manure and contaminate the growth chamber.

Yet another object of the present invention is to provide an improved chicken growth facility or chicken house with a ventilated floor assembly having side-by-side ventilated plastic modules interlocked with and supporting ventilated floor sections together with a waterproof barrier underneath to serve as a heat insulator to insulate the higher temperature of the chicken house growth chamber from the much lower ground temperature.

Still yet another object of the present invention is to provide an improved chicken growth facility or chicken house with a floor heat insulator comprised of a ventilated floor assembly in combination with a waterproof film barrier underneath which insulator reduces the effect of the ground acting as a heat sink to draw the moisture in the growth chamber towards the floor in warm weather and prevents moisture from rising up out of the ground during cold weather.

Another object of the present invention is to provide an improved chicken growth facility or chicken house that achieves a reduction in the production of ammonia by reducing the moisture content of the manure to between about 20% and about 30%, and a pH of the manure between about 5.0 and about 7.0.

A further object of the present invention is to provide an improved chicken growth facility or chicken house with a passive ventilated floor assembly which achieves the desired manure moisture content and manure pH level in accordance with the preceding object without the need for additional air blowers associated with the bottom plenum.

Still another object of the present invention is to provide a chicken house in accordance with the preceding object that includes a passive ventilated floor assembly having a ventilated floor through which air and liquid can easily flow but which retains substantially all of the solids on its upper surface, together with a bottom air plenum underneath the ventilated floor.

A still further object of the present invention is to provide a passive ventilated floor assembly which is made of molded plastic modular components that can be assembled in an interlocked rigid floor assembly, including a ventilated floor, a bottom or floor air plenum below the ventilated floor and open vents between the floor plenum and the growth chamber, preferably along the sides of the chicken house, so that manure retained on the ventilated floor can be dried from above in the growth chamber and from below through the floor plenum.

Still another object of the present invention is to provide a chicken house in accordance with the preceding objects that includes a ventilated floor assembly having a center line that runs the length of the house with each side of the floor assembly with respect to the center line sloping downwardly toward the left and right sides of the house.

A further object of the present invention is to provide a chicken house in accordance with the preceding object in which drains are provided along the longitudinal sides of the chicken house that, in combination with the sloped side of the floor, facilitate the collection of cleaning water when the floor assembly is washed down in between different chick flocks.

Another object of the present invention is to provide a chicken house in which a layer of crushed stone, gravel or other compressible material is laid under the vapor barrier when the chicken house is installed over a soft ground surface to ensure that the floor assembly of the present invention can readily support vehicular traffic thereon.

Yet another object of the new and improved chicken house of the present invention is to provide a more favorable environment for the chicken flock to remain healthy and grow to full weight.

An additional object of the present invention is to provide improved structures and methods for creating pressure differentials in chicken growth facilities for flushing undesired gasses from the facilities, including carbon dioxide from around the chickens.

Yet a further object of the present invention is the provision of structures and methods for effecting enhanced harvesting capability in chicken growth facilities.

Still yet a further object of the new and improved chicken house of the present invention is to provide a more favorable environment for the chicken workers by improving or eliminating noxious gases and/or airborne related health problems.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a front-end elevation of a chicken house equipped in accordance with an active embodiment of the present invention with the forward wall removed for permitting illustration of the interior structure;

FIG. 2 is a right front perspective view of the interior and exterior portions of the chicken house of FIG. 1 with structural portions being removed for clarity;

FIG. 3 is a top plan view of the chicken house of FIG. 1 with upper portions of the roof removed to permit illustration of the interior construction;

FIG. 4 is a right side elevation view of the chicken house of FIG. 1;

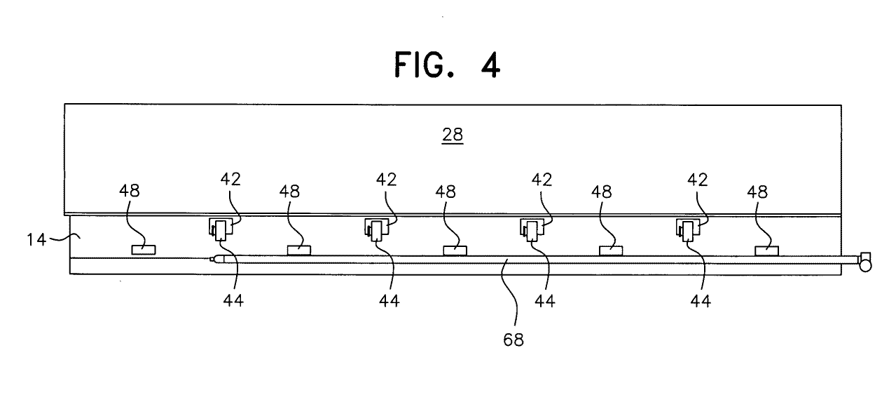

FIG. 5 is a perspective view of the forward left portion of the chicken house of FIG. 1 with the front wall removed for clarity;

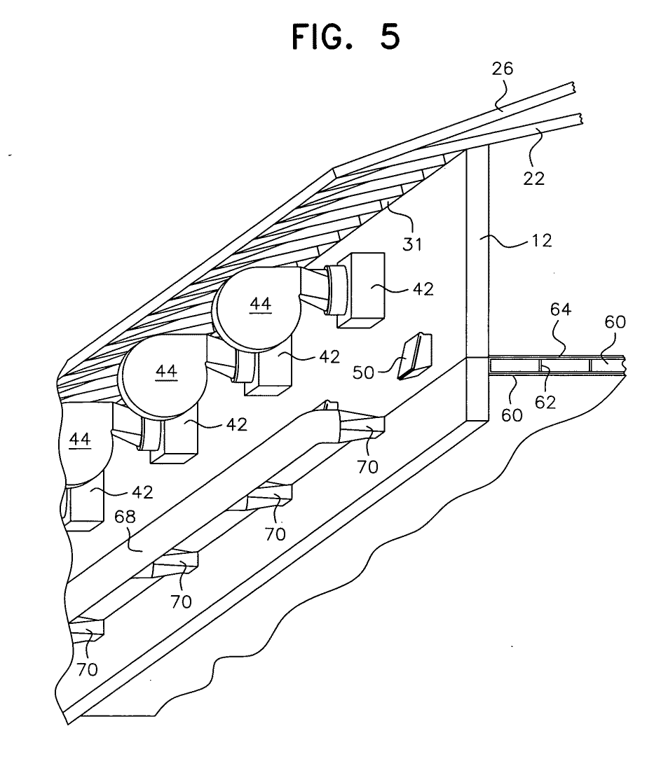

FIG. 6 is a perspective view of a portion of the forward right wall and adjacent floor section of the chicken house of FIG. 1 with the front wall removed for clarity;

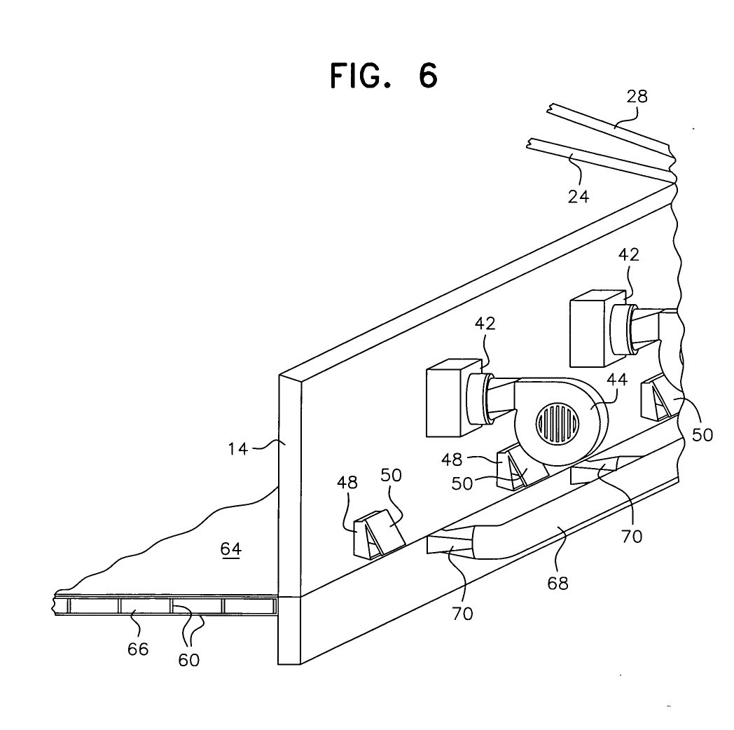

FIG. 7 is an exploded perspective view of one embodiment of a ventilated floor assembly for a chicken house in accordance with the present invention including three component elements thereof.

FIG. 8 is an exploded perspective view of a ventilated modular floor section and a bottom floor module which when assembled together and with similar side-by-side components make up a preferred embodiment of a ventilated floor assembly in accordance with the present invention.

FIG. 9 is an exploded perspective view of the floor components shown in FIG. 8, but looking from underneath of the components.

FIG. 10 is an enlarged perspective view of the floor components shown in FIG. 8, with the components connected by fitting the depending projections or bosses of the floor section into respective circular openings in the truncated top surface of the support members or spacers of the bottom floor module.

FIG. 11 is a side elevation view of the floor components shown in FIG. 8, in assembled condition, as shown in FIG. 10.

FIG. 12 is a top plan view of the floor components shown in FIG. 8, when assembled in a staggered relationship in accordance with the present invention.

FIG. 13 is a perspective view of multiple bottom floor modules positioned for assembly in interlocked side-by-side relation in accordance with the present invention.

FIG. 14 is a perspective view of the bottom floor modules shown in FIG. 13, but looking from underneath the modules.

FIG. 15 is a front and side perspective view of a conventional chicken house showing the exhaust fans in the front wall which create tunnel or laminar ventilation in the chicken house and with a portion of the roof cutaway to show a passive ventilated floor system incorporated in the chicken house in accordance with the present invention.

FIG. 16 is a rear and side perspective view of the chicken house of FIG. 15 showing negative pressure operated flaps or cold water cooling pads in the back wall which open under negative pressure in the chicken house created by the exhaust fans, with a lower portion of the back wall and back side wall cutaway to show the passive ventilated floor system.

FIG. 17 is a front-end elevation of the chicken house of FIGS. 15 and 16, with the forward wall removed to illustrate the interior structure.

FIG. 18 is an enlarged view of the area designated “A” as shown in FIG. 17.

FIG. 19 is a top view of a plurality of bottom modules in accordance with another embodiment of a ventilated floor assembly in accordance with the present invention.

FIG. 20 is a perspective view of the support elements and flat base component of two bottom modules of the floor assembly of FIG. 19, showing the beveled edges on the interlocking elements.

FIG. 21 is a lower perspective view of the support elements and base components shown in FIG. 20.

FIG. 22 is a cutaway perspective view of two of the support elements of a bottom module in accordance with another embodiment of the floor assembly of the present invention.

FIG. 23 is a bottom view of part of the bottom modules shown in FIG. 22 looking into the hollow interior of a support element.

FIG. 24 is a top view of the support element and bottom module part shown in FIG. 23.

FIG. 25 is a bottom view of the floor as assembled, showing both the interior of the bottom module support element and the interlocked projection or boss of the floor section.

FIG. 26 is a side view of a plurality of bottom modules of FIG. 22 in which the modules are in a stacked configuration.

FIG. 27 is a top view of a floor section assembled to an underlying bottom module and showing slots for the openings in the floor section in accordance with the present invention.

FIG. 27A is a cross-sectional view of the slotted openings in a floor section along line B-B in FIG. 27 showing a tapered slot opening.

FIGS. 27B and 27C are a perspective top view and a perspective bottom view, respectively, of a portion of a floor section of a different tapered slot from that shown in FIG. 27A.

FIG. 27D is a cross-sectional view of the slotted openings in the floor section illustrated in FIGS. 27B and 27C taken along line C-C in FIG. 27B.

FIG. 28 is a bottom view of an assembled floor section like that shown in FIG. 27.

FIG. 29 is a lower perspective view of the bottom module being brought close to engagement with the floor section of FIG. 27.

FIG. 30 is a lower perspective view of the bottom module as engaged with the floor section of FIG. 27.

FIG. 31 is a partial cutaway perspective view of the bottom module as engaged with the floor section of FIG. 27, showing the engagement between the flanged ledge and the tooth on the floor section boss.

FIG. 32 is an upper perspective view of four floor sections of FIG. 27 as arranged to have their overlapping projecting ledges and supporting shelves interlock when brought into abutment.

FIG. 33 is an enlarged view of the area marked “A” as shown in FIG. 34.

FIG. 34 is a side perspective view of two adjoining floor sections being brought into an overlapping configuration and joined with a bottom module.

FIG. 35 is a side perspective view of the adjoining floor sections of FIG. 34 as assembled with the bottom module.

FIG. 36 is a photograph of the inside of an actual chicken house having a passive ventilated floor assembly in accordance with the present invention, showing the top of the floor assembly, the food stations, water dispensers and chicks.

FIG. 37 is a top perspective view of grid layers constructed as a mound for placement under the water dispensers of FIG. 36.

FIG. 38 is a side perspective view showing the grid mound of FIG. 37 with a water dispenser and chick.

FIG. 39 is a perspective view of a conventional chicken house with a portion of the roof and the front wall cut away to show a passive ventilated floor assembly incorporated in the chicken house in accordance with the present invention with exhaust pipes spaced longitudinally along the center crown of the ventilated floor to allow air and humidity (moisture) which might collect underneath the floor crown to escape into the growth chamber.

FIG. 40 is a perspective view of a conventional chicken house with a portion of the roof and front wall cut away, similar to FIG. 39, to show a passive ventilated floor assembly incorporated in the chicken house in accordance with the present invention with exhaust fans spaced longitudinally along the center crown of the ventilated floor to exhaust air and humidity (moisture) which might collect underneath the crown.

FIGS. 41A, 41B, 41C and 41D are various views of one of the exhaust fans for use in the chicken house of FIG. 40.

### DETAILED DESCRIPTION AND PREFERRED EMBODIMENTS

In describing preferred embodiments of the present invention, specific terminology will be used for the sake of clarity. However, the invention is not intended to be limited to the specific terms as selected. Therefore, it is to be understood that each specific term includes all technical equivalents, which operate in a similar manner to accomplish a similar purpose.

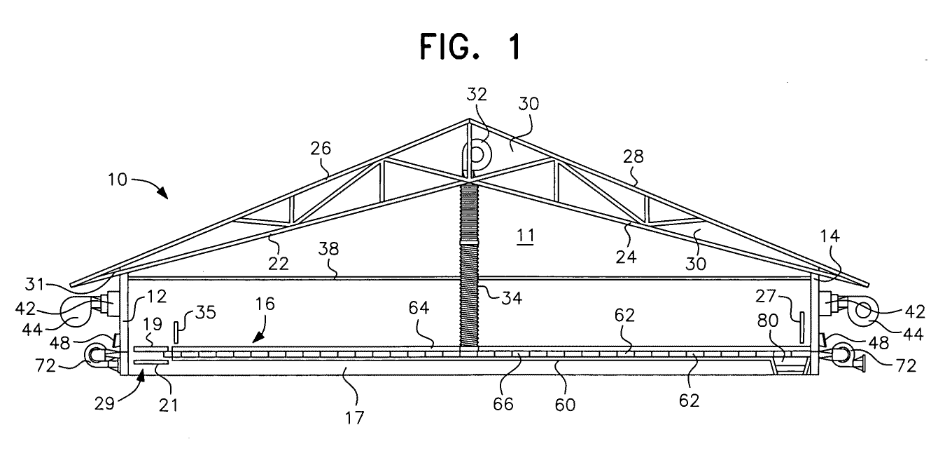

Turning initially to FIG. 1, a chicken growth facility or chicken house in accordance with an active system of the present invention is generally designated by reference numeral 10. The chicken house 10 can be either a newly constructed chicken house equipped in accordance with the present invention or an existing structure which is renovated and partially reconstructed, i.e., retrofitted, to incorporate an active embodiment of the apparatus and method of the present invention.

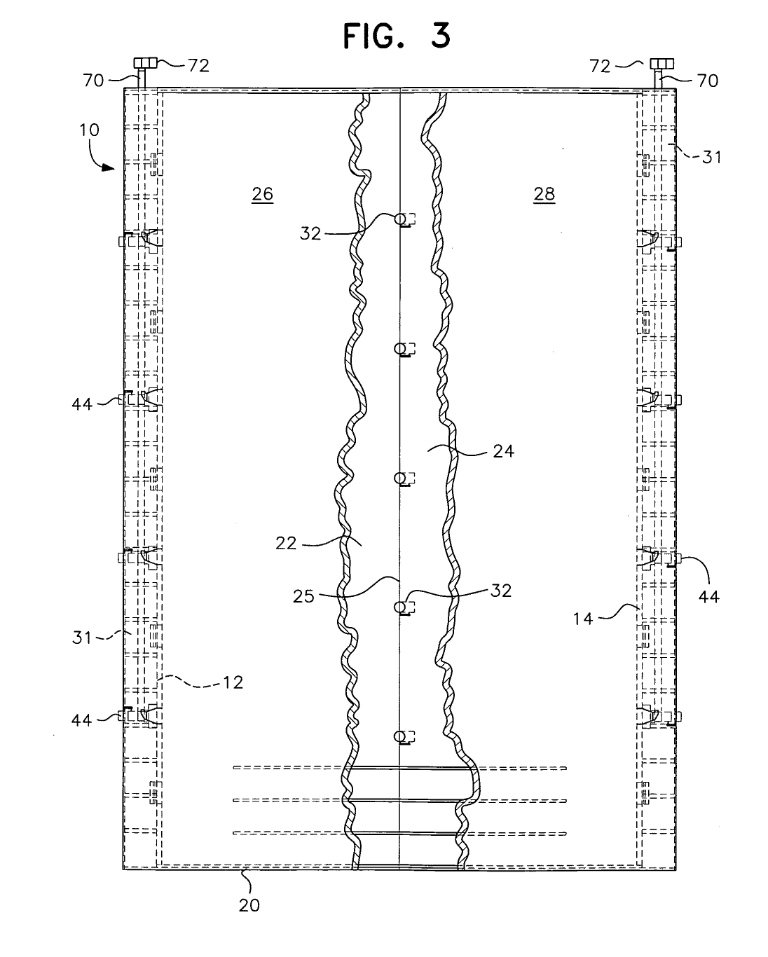

The chicken house 10 provides an elongated growth chamber 11 generally defined by a left side wall 12, a right side wall 14, a rear wall 18, a front wall 20, and left and right ceiling panels 22 and 24, which are connected by a vertical front to rear center plane 25 (FIG. 3). Additionally, truss-supported left roof panel 26 and right roof panel 28 are connected to center plane 25 and cooperate with ceiling panels 22 and 24 to provide a ceiling plenum 30 extending the entire length of the house. This structure is typical of existing chicken houses with the floor formed by the ground on which bedding litter approximately 6 inches thick has been placed.

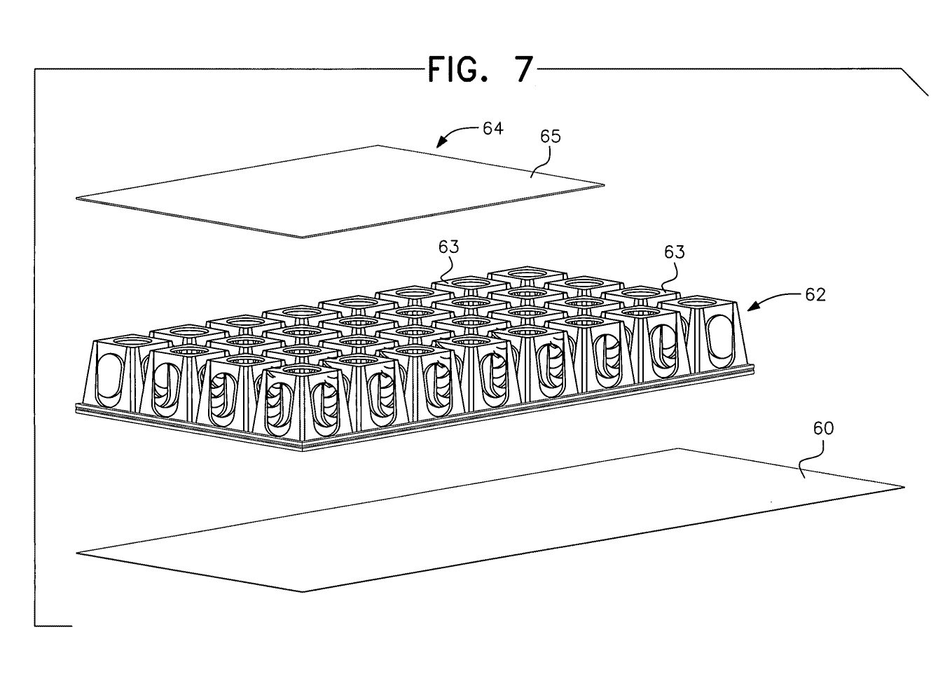

Instead of the conventional bedding litter and ground as the floor, the present invention utilizes a ventilated floor assembly, generally designated by reference numeral 16, which extends between side walls 12 and 14 and end walls 18 and 20 and constitutes the entire floor of the growth chamber 11. The upper component of the floor assembly 16 is a ventilated floor 64, which in one embodiment can be formed of a conventional geotextile carpet 65 typically used for earth stabilization and drainage. In this embodiment, the carpet 65 is supported by a plurality of side-by-side unique ventilated hollow plastic modules 62 which comprise a second component. The modules 62, in turn, rest on a plastic vapor barrier 60, which comprises a third and lower component of the sandwich-like floor assembly 16, see FIG. 7. The plastic vapor barrier 60 is designed to rest on the earth surface 17, which thus supports the floor assembly 16 of the chicken house.

The geotextile carpet 65 is typically formed of liquid non-absorbent knitted plastic threads or cords, as well known in the earth stabilization and drainage industries. One geotextile carpet suitable as the ventilated floor for the present invention is marketed under the designation US 1040 by U.S. Fabric Company of Cincinnati, Ohio. The US 1040 carpet is manufactured in widths of 12 and 16 feet which can be adhesively bonded along their edges to form a unitary carpet 65 that covers the floor of the typical chicken house which is 40 or 60 feet wide and 500 or 600 feet long. Liquid and gas can flow through the geotextile carpet 65; however, the geotextile carpet is sufficiently closely woven to support even the smallest chicks as well as their manure deposited on the upper surface of the carpet. It should be understood that carpet 65 can also be formed of other materials, such as metal mesh or screens or woven plastic materials, and one preferred embodiment is described hereinafter.

The ventilated rectangular plastic modules 62 (FIG. 7) which form the middle component of floor assembly 16 have an egg crate type structure to provide a hollow interior through which liquid and gas can easily flow from the lower surface of carpet 65 into and laterally throughout the middle component of the floor assembly 16. Each module 62 is preferably molded of a suitable polymeric material and comprises a unitary structure having a rectangular plan shape of approximately 2 feet by 4 feet and a height of about 2 inches, but can vary depending on conditions and manufacturer. Each module 62 includes a plurality of hollow-tapered bottomless columns 63 having an approximately square outer cross-section and a peripheral rectangular base frame 67. Each column 63 tapers inwardly from bottom to top, and modules 62 can consequently be stacked for shipment and/or storage in a nested mating manner in which the columns 63 of a lower module are each matingly received within the interior of corresponding columns in the next upper module.

The waterproof vapor barrier 60 comprising the lower component of the floor assembly 16 is preferably made of an impermeable inert polymeric material, such as approximately 6 to 8 mils thick polyethylene sheeting or the like. The barrier extends upwardly about the sides and ends of the outer modules 62 to define a floor plenum 66 in which a partial vacuum can be created to aid in air and liquid flowing from growth chamber 11 downwardly through geotextile carpet 65. Such air flow through manure resting on carpet 65 in the active system results in drying of the manure. Further, the pressure differential between the growth chamber 11 and the floor plenum 66 causes moisture flowing through carpet 65 to more readily vaporize. Air, water, vapor and gases, such as ammonia, methane, and carbon dioxide, in plenum 66 are removed by two vapor and gas removal conduits 68 which are respectively provided externally of left wall 12 and right wall 14, as best shown in FIG. 1, and described hereinafter. Any liquid build-up in plenum 66 can flow into a liquid removal trough 80 extending along the right side wall 14. A similar trough can also be provided along left side wall 12, if needed.

The interior of conduits 68 communicate with the vacuum plenum 66 by means of four or more hollow connection pipes 70 each having one end communicating with the floor plenum 66 and the other end communicating with the interior of vapor removal conduit 68. The rear end of each vapor removal conduit 68 is connected to an electrically driven suction blower 72 to cause negative (sub-atmospheric) pressure in floor plenum 66 and removal of gas and air from plenum 66. Operation of the suction blowers 72 in this active system consequently creates a pressure drop between the upper surface of manure deposited on geotextile carpet 65 and plenum 66, thus causing air to flow downwardly through the manure to effect drying of the manure. The air flow also causes movement of moisture and/or liquid and noxious gases to flow through the manure and carpet 65 into the plenum 66 from which it is then removed by gas and vapor removal conduits 68 and suction blowers 72 for discharge from the chicken house. Such air flow does not have to result solely from operation of blowers 72 but can be increased and aided by evaporative cooling blowers 44, described hereinafter, which create positive air pressure in growth chamber 11.

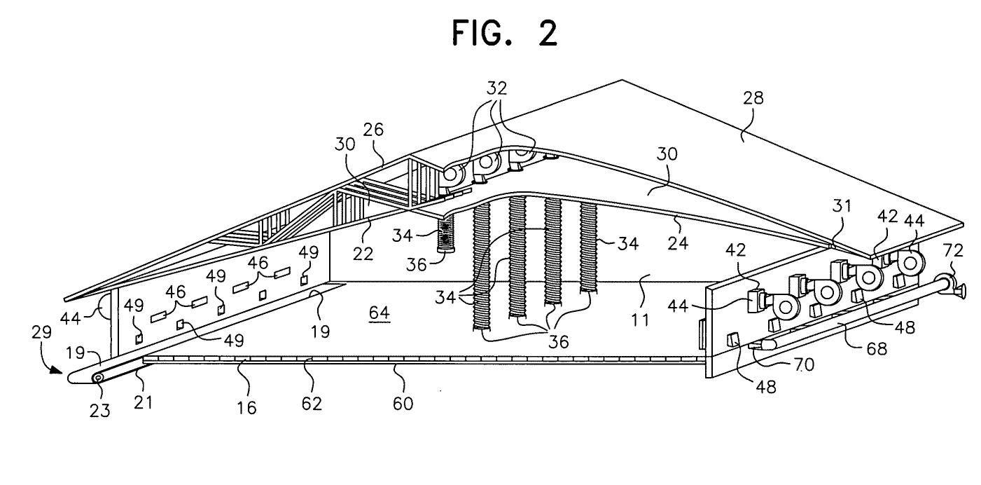

Ceiling plenum air blowers 32 can be provided in the ceiling plenum 30 with each blower having an inlet communicating with the air in plenum 30 so that blower operation can pull fresh air in through air inflow openings 31 in the eaves of structure 10. Blowers 32 each have an outlet discharging into a downwardly extending conventional pleated conduit tube 34 having a lower end 36 through which air from its respective blower is discharged. The lower end 36 of conduit tubes 34 extends flush to carpet 65 allowing air to flow into the floor plenum 66. Thus, the warm air in the ceiling plenum 30 can be discharged from the lower ends 36 of pleated conduit tubes 34 into the floor plenum 66 from which it rises (warm air rises) through ventilating carpet 65 to warm the growth chamber 11, which is particularly beneficial during the growth of baby chicks at the beginning of the growth cycle. The length of each pleated conduit tube 34 can be adjusted to vary the elevation of its lower end 36 above the upper surface of ventilated floor assembly 16 as exemplified by the four conduit tubes shown in FIG. 2 which have lower ends 36 in the floor and the shortened remaining conduit tube which has its lower end 36′ in an elevated position.

A plurality of energy-saving indirect evaporative coolers 42 are fitted in each of side walls 12 and 14 for providing fresh and cool air in growth chamber 11 when required by ambient temperature conditions. Each cooler is preferably one of the types disclosed in Maisotsenko et al. U.S. Pat. No. 6,854,278, the disclosure of which is expressly incorporated by reference as if fully set forth herein. Coolers 42 employ an indirect evaporative cooling process that evaporates water in one chamber and cools an air stream in an adjacent chamber as discussed in detail in the aforesaid Maisotsenko et al. patent. Each cooler 42 is associated with a blower 44 which moves the air through the cooler where the air is cooled during warm weather prior to movement through openings 46 (see FIG. 2) in side walls 12 and 14. Movement of the air through openings 46 acts to create positive air pressure in growth chamber 11. Simultaneous operation of plenum air blowers 32 and blowers 44 of the indirect evaporative coolers should be carried out to provide the optimum air pressure in chamber 11.

The positive pressure generated in growth chamber 11 by the air flow from blowers 44 also acts to remove carbon dioxide which accumulates near ventilated floor assembly 16. More particularly, openings 49 are formed near the bottom of side walls 12 and 14, slightly above floor assembly 16, which connect to floor exhaust pressure relief valves 48 having flaps 50 which open in response to excessive pressure in growth chamber 11. Hence, when the positive air pressure in growth chamber 11 reaches a specified level adjacent a relief valve 48, say about 1-2 psig, the associated flap 50 will automatically open and force carbon dioxide, which may have accumulated adjacent the growing chickens, out of the chicken house.

Coolers 42 and blowers 44 are capable of providing sufficient cool air to compensate for the animal heat of the chickens during warm weather which can be as much as 5 BTU/lb/hr or approximately 1,100,000 BTU/hr in a 30,000 sq. ft. chicken growth chamber. Such volume of air is more than sufficient to flush carbon dioxide gas from the facility, properly oxygenate the air surrounding the chickens and provide the chickens with appropriate temperature for optimal development. It should also be noted that warming of the interior of growth chamber 11 can be aided by use of existing forced air gas heaters in existing structures being modified to practice the present invention or by the incorporation of such gas heaters in a new building being constructed for practice of the invention.

Maximum downward airflow through ventilated floor 64 occurs when cooling blowers 44 and suction blowers 72 are simultaneously operated; however, operation of either one of these blowers should be adequate to create a sufficient volume of air flowing downwardly through the manure and ventilated floor 64 to dry the manure. The drying of the manure prevents liquid (moisture) build-up in the manure so as to preclude or reduce the formation of ammonia and pathogens (and perhaps methane) substantially below that which would otherwise occur using conventional methods and structures.

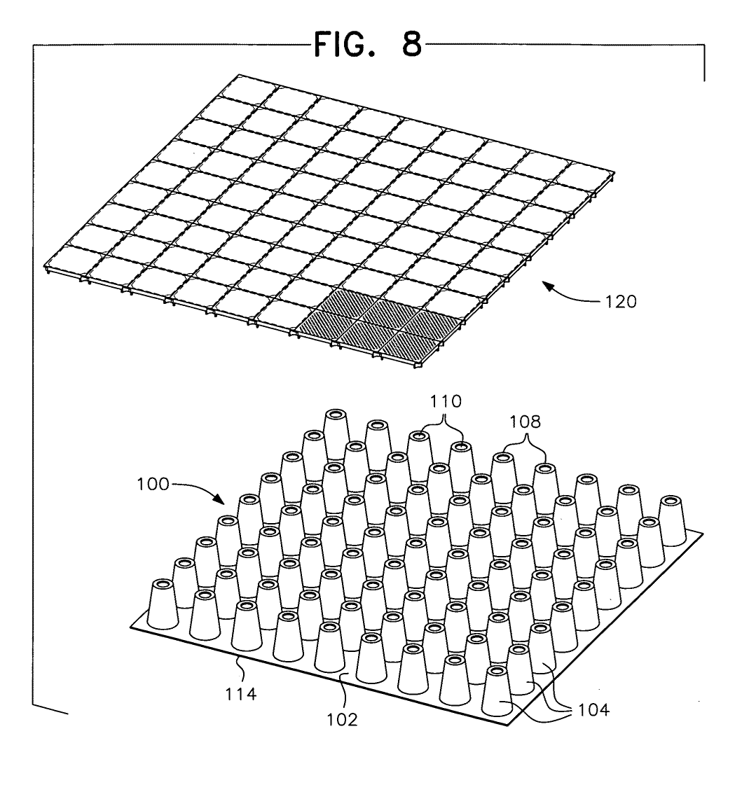

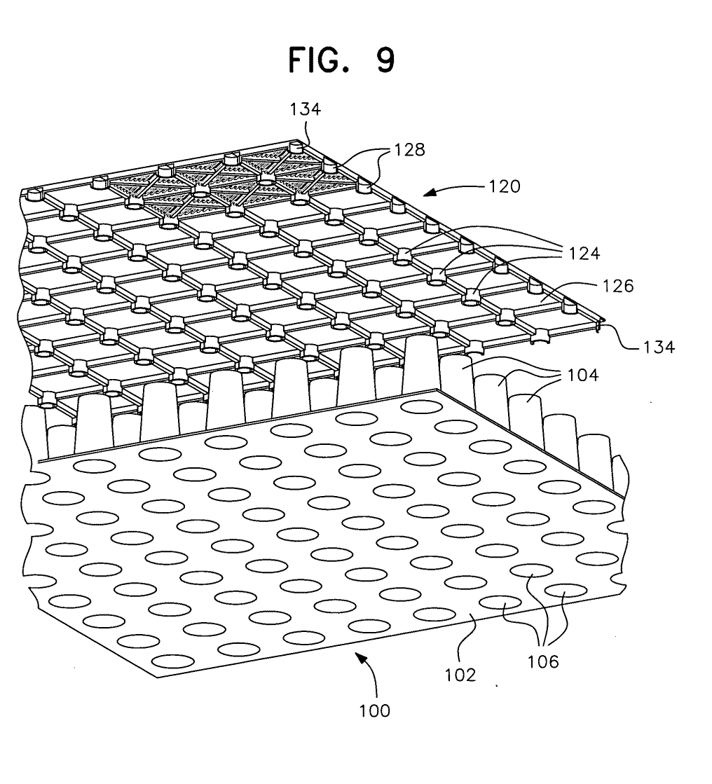

One embodiment of components for the ventilated floor assembly 16 is illustrated in FIGS. 8-14, and this two component floor assembly is generally designated by reference numeral 98. In this embodiment, the plastic vapor barrier 60 and ventilated hollow plastic modules 62 previously described are combined into a unitary bottom floor module, generally designated by reference numeral 100. Each bottom floor module 100 includes a flat base component 102 and a plurality of upstanding hollow support elements or spacers 104. The support elements or spacers 104 are preferably cone-shaped tapering downwardly from the top to the bottom. The cone-shaped support elements are hollow and open at the bottom at 106, see FIG. 9. The support elements 104 are also truncated at the top to provide a flat upwardly facing support surface 108 with a circular opening 110 at its center.

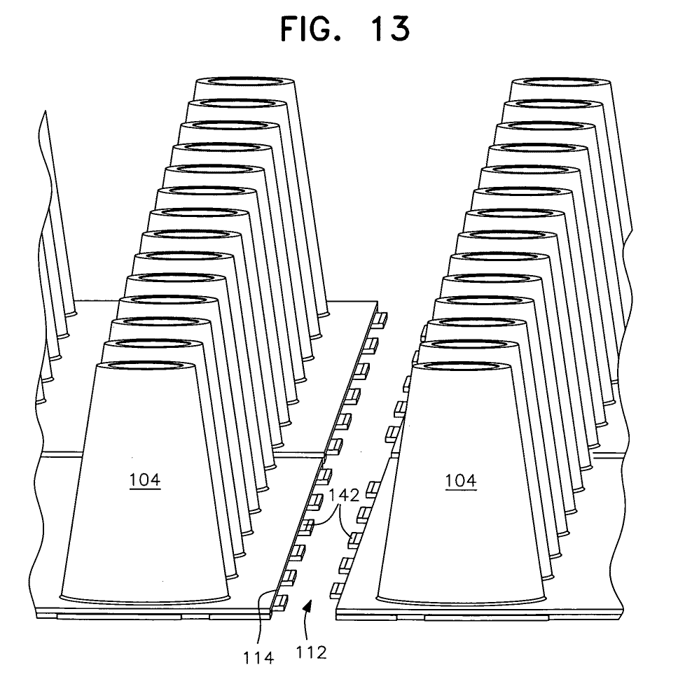

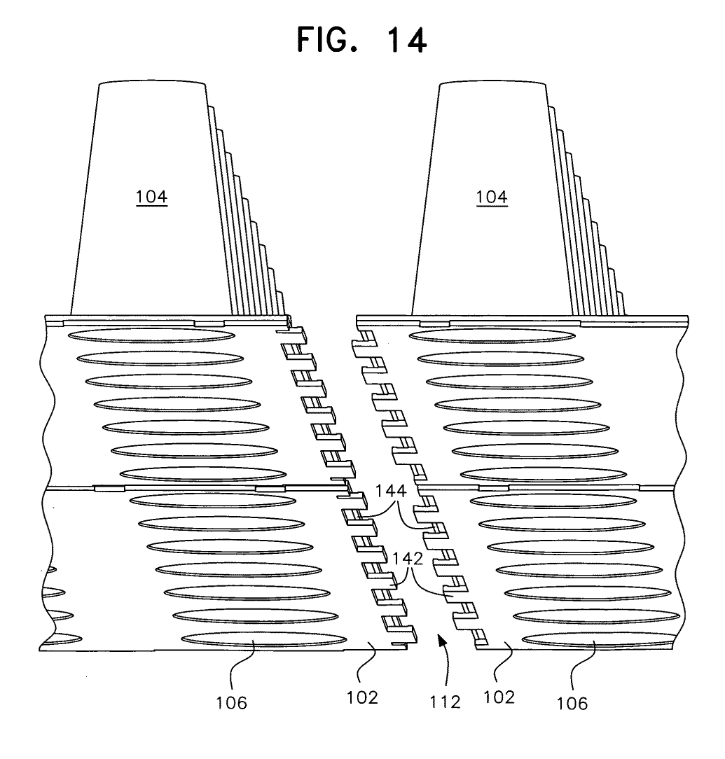

The unitary bottom floor modules 100 are preferably injection molded of suitable polymeric material. Modules 100 include interlocking elements 112 along the side edges 114 of each flat base component 102, see FIGS. 13 and 14. When the bottom floor modules are placed side-by-side on the ground, the interlocking elements 112 are engaged so that the flat base components 102 of the modules 100 cover the entire ground surface of the chicken house.

In this embodiment, the ventilated floor 64 is made up of a plurality of ventilated modular floor sections, generally designated by reference numeral 120, which have the same rectangular size and shape, preferably square, as the base 102 of the bottom floor modules 100. The rectangular floor sections 120 are also injection molded of a suitable polymeric material and include a large number of small holes 122 extending completely therethrough. The holes 122 are sized to allow air and other gases to pass therethrough but retain the manure and other solids on their upper surface.

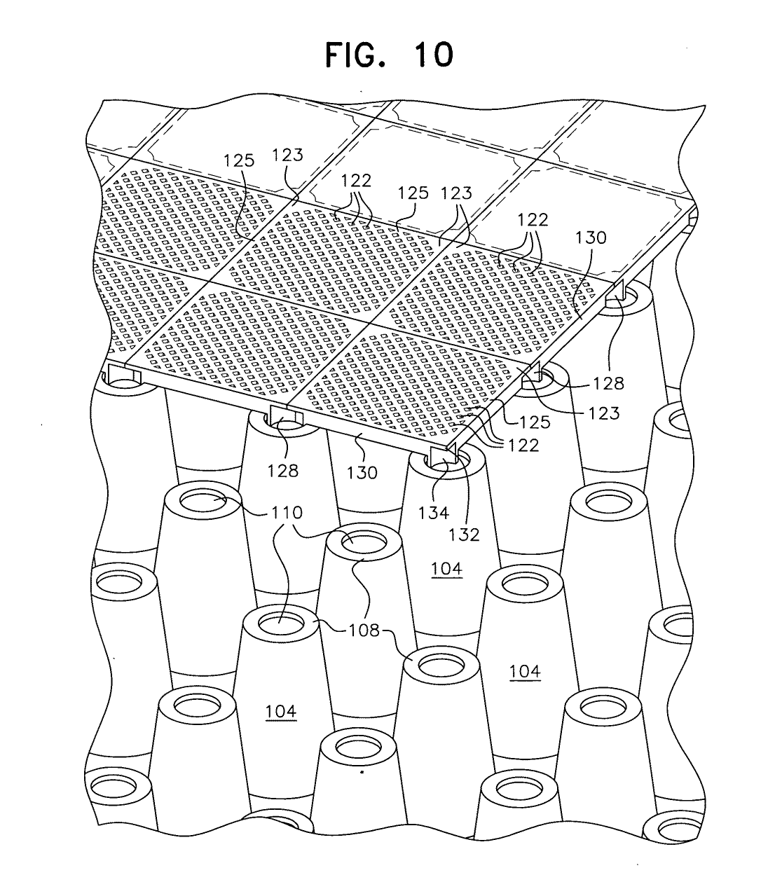

The floor sections 120 also include cylindrical projections or bosses 124 which extend from the lower surface 126 and are sized to pressure-fit or snap-in fit for interlocking into respective circular openings 110 in the tops of the support elements or spacers 104. As shown in FIGS. 9 and 10, the projections 128 along the side edges 130 of the floor sections 120 are only half cylinders such that they fit into only one-half of the openings 110 in spacers 104. The other half of the opening 110 is filled by the mating mirror image half cylinder 128 of the adjacent floor section 120. At the corners 132 of each floor section 120, the projection 134 is reduced to a quarter-round projection so that when the ventilated floor sections 120 are set side-by-side, the quarter-round depending projections 134 at adjacent corners of four sections are fitted into the same opening 110.

While support elements or spacers 104 are preferably cone shaped, tapering downwardly from the top to the bottom, other cross-sectional shapes such as triangular, square, hexagonal, etc. can be employed without departing from the present invention. Further, while the projections or bosses 124, 128 and 134, as well as spacer openings 110 are preferably circular, other cross-sectional shapes such as square, octagonal, etc. could be utilized as would be understood by those skilled in the art.

It will be seen that holes 122 cover most of the surface of sections 120, except areas 123 where projections or bosses 124, 128 and 134 are positioned, and along side edges 125, see FIG. 10. The areas where the projections or bosses 124, 128 and 134 project from the bottom surface of the section 120 remain solid (non-perforated) to ensure a seal from underneath the floor assembly 98. This is because the cone-shaped elements or spacers 104 are hollow for the injection molding and, therefore, open at the bottom, at 106. This seal prevents the intrusion of darkling beetles surfacing from the ground and feeding from the chicken manure retained on the ventilated floor formed by sections 120.

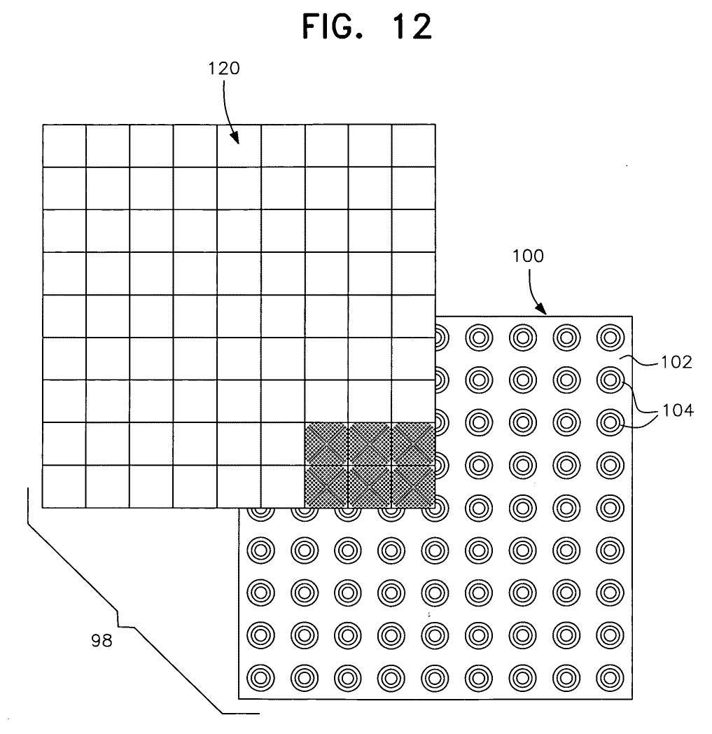

The bottom floor modules 100 are interlocked along their side edges 114 by interlocking elements 112. One embodiment of the interlocking elements 112 is shown in FIGS. 13 and 14 and take the form of staggered projections 142 and recesses 144, which interlock each flat base component 102 to its adjacent flat base component 102 of the adjacent bottom floor modules 100. The ventilated floor sections 120 are preferably staggered with respect to the bottom modules 100 such that there is a one quarter area overlap, as shown in FIG. 12. Hence, each floor section 120 preferably overlies an adjacent one quarter area of four adjacent and interconnected bottom floor modules 100. This staggered relationship produces an overall ventilated floor assembly 16 which is in the form of an interlocked unitary structure covering the entire floor surface of the chicken house. Such interlocked unitary ventilated floor assembly should be sufficiently strong and rigid so as to support vehicular traffic typically used in a chicken house. Around the side edges of the assembly 98, unmated portions of the floor sections 120 and bottom floor modules 100 can be trimmed as desired.

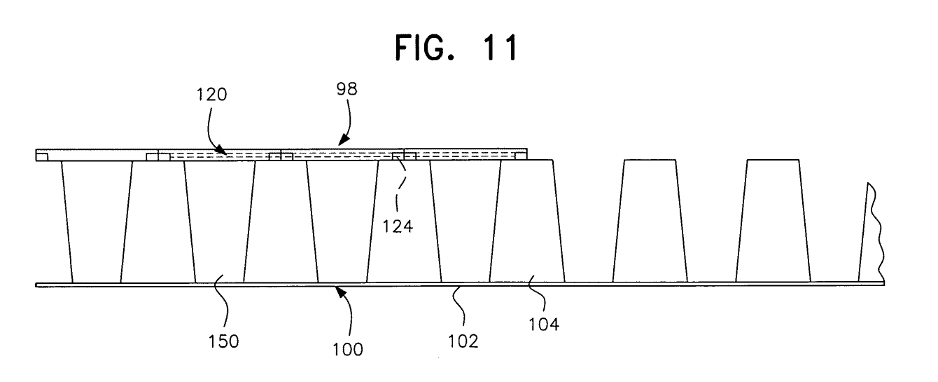

Once assembled into the ventilated floor assembly 98, the interlocked floor sections 120 and bottom floor modules 100 form a bottom floor plenum 150, either open or closed, underneath the ventilated floor (see FIG. 11), which operates in the same way as previously described floor plenum 66 in the earlier embodiment of floor assembly 16 utilizing the geotextile carpet 65. All of the other components of the chicken house remain the same and operate in the same way. Hence, when suction blowers 72 cause a negative (sub-atmospheric) pressure in floor plenum 150, the pressure drop between the upper surface of the rectangular floor sections 120 and the floor plenum 150 causes the air and other gases in the growth chamber 11 to flow downwardly through the manure and openings 122 to effect a drying of the manure and removal of the noxious gases from the growth chamber.

A preferred method for assembling the two component floor assembly 98 is to place four bottom modules 100 interlocked among themselves onto the ground where the floor assembly 98 is to be assembled. A ventilated top section 120 is then placed in the center of the square created by the four interconnected bottom floor modules 100 to thus engage the adjacent one-quarter sections of the four bottom pieces together by interlocking the projections 124, 128 and 134 into their respective openings 110 of the cone-shaped spacers 104. Bottom floor modules 100 and floor sections 120 are then respectively interlocked in the direction desired, until the entire ventilated floor assembly 98 has been erected. At the end there will be exposed (unmated) bottom floor modules 100 and/or rectangular floor sections 120 along the perimeter of the floor assembly. These modules and/or sections can be cut to have matching side edges for the ventilated floor 64 and base components 102.

In the floor assembly 98 shown in FIGS. 8-14, the bottom floor modules 100 and matching floor sections 120 are both about 18 inches square. The cone-shaped hollow spacers or studs 104 are approximately 2½ inches tall protruding from the solid square flat base component 102. The holes 122 of the floor sections 120 are preferably square, approximately 93 mils on each side. In accordance with the present invention, the size of holes 122 can vary from as little as about 0.030 inches square to as large as about ⅛ inch square, and the holes 122 comprise a minor portion of the total surface area of the section 120. In particular, testing of the floor assembly of the present invention has determined that the total area of holes 122 should comprise about 2% to about 25% of the total area of floor section 120, preferably between about 3% and about 12%, and most preferably between about 4% and about 6%. The projections or bosses 124, 128 and 134, and associated circular openings 110 in the top of hollow cone-shaped spacers 104 are preferably about ⅜ inch to about ½ inch in diameter.

The flat base component 102 of the bottom floor module 100 has a smooth upper surface and, when interlocked to form the ventilated floor assembly 98, allows the air and other gases to flow around the cone-shaped spacers or studs 104 in all directions with no entrapment areas. The ability to tightly interlock the base components 102 as well as the round shape of the spacers 104 allows for less air resistance, or better air flow, of the air and other gases through the plenum 150 and also provides for a smooth surface for wash down if necessary with no entrapment areas.

Preferably, a waterproof film barrier is positioned underneath the ventilated floor assembly 98 and over the ground surface or concrete floor, which would otherwise form the bottom of the chicken house. The ventilated floor assembly together with the waterproof film barrier form a heat insulator which reduces the effect of the ground acting as a heat sink to draw the moisture in the growth chamber towards the floor, in warm weather, and prevents moisture from rising up out of the ground or concrete floor, during cold weather. This insulating action of the combined ventilated floor assembly and waterproof film barrier thus serve to reduce the moisture content of the manure (feces) which accumulate on the top of the floor assembly. Further, the waterproof film barrier serves to prevent contaminated water from passing through the floor and invading the water table in the ground in the event a water line break occurs in the growth chamber of the chicken house.

The present invention also may include a unique conveyor system for harvesting the grown chickens at the end of the growth cycle and removing the dried manure after chicken harvesting. Specifically, fowl removal conveyor 29 extends adjacent along left side wall 12. The conveyor 29 includes a horizontal upper flight 19 and a lower horizontal flight 21 supported by an upstream support roller (not shown) and a downstream support and drive roller 23 (FIG. 2).

A movable pusher wall 27 extends along the length of right side wall 14 during the entire growth period and is used at harvest time, in a manner to be described, for gently positioning the fowl onto removal conveyor 29. More specifically, pusher wall 27 is supported by pulleys (not shown) riding on transverse support cables 38 extending across the width of growth chamber 11 between walls 12 and 14. Power actuated winches (not shown) are operable for also lifting pusher wall 27 to an elevated position from the position illustrated in the drawings to enable maintenance equipment to be operated on ventilated floor assembly 19. Additional power-driven winches (not shown) are provided with cables connected to pusher wall 27 for slowly moving pusher wall 27 from its FIG. 1 position adjacent right wall 14 to a position adjacent the right side of upper flight 19 of fowl removal conveyor to effect positioning of ready-to-harvest poultry on upper flight 19.

A vertically movable side gate 35 is supported for vertical movement by support cables and power-driven winches (not shown) adjacent the right side of upper flight 19 during the growth period of the fowl to prevent the fowl from moving onto and fouling upper flight 19. However, at harvest time, side gate 35 is lifted by the power-driven winches to an elevated position to permit the fowl to be moved onto upper flight 19 by pusher wall 27 and also to permit operation of maintenance equipment on ventilated floor assembly 19. While the primary purpose of the conveyor 29 is to remove the grown chickens from the chicken house at harvest time, conveyor 29 can also be used, with side gate 35 in its down position, by the farmer, to remove dead birds culled from the flock during the growing cycle.

The operation of the various blowers for an active system of the present invention will now be described for a chicken growth cycle. A complete growth cycle for chickens typically extends over about a seven-week period and comprises three distinct growth periods, each of which involves progressively controlling the environment in the growth chamber 11 in accordance with the changing needs of the fowl as they progress from baby chick status to mature harvest status.

The first growth period comprises the first two weeks of growth, during which the indirect evaporative coolers 42 and suction blowers 72 are not operated and floor exhaust valves 48 are closed. However, the plenum air blowers 32 are activated and warm air in ceiling plenum 30 is forced downwardly for discharge from the lower ends 36 of the pleated conduit tubes 34. The pleated conduit tubes 34 have their lower ends in their lowermost position in the floor plenum 66 of the floor assembly 16 so that the warm air is forced back up through the carpet 65 or floor sections 120 to heat the baby chicks from underneath. This upward heating provides better and more uniform heat for the small chicks. Such heating is likely necessary even in the summer for the small chicks during the first growth period. Ambient fresh air, as needed, can be pulled into ceiling plenum 30 through openings 31 by blowers 32.

In addition, or alternatively, to the warm air from the ceiling plenum 30, heated air from the heated air ventilating system of the chicken house may be introduced directly into the floor plenum to provide the upward heating to the small chicks.

The second growth period consists of the three weeks following the first growth period. During the second growth period the pleated conduit tubes remain in their lowest position and provide forced air flowing from the ceiling plenum as described in the preceding paragraph. Cooling blowers 44 are also activated to maintain positive pressure in the growth chamber and are controlled at required levels by the opening of valves 48. However, cooling units 42 through which blowers 44 discharge air are not normally operated during this second growth period.

The third, and last, growth period consists of the last two weeks of the growing cycle. During this period, the floor exhaust pressure relief valves 48 are operative to relieve excessive pressure and discharge carbon dioxide. Pleated conduit tubes 34 remain in their lowered position and plenum air blowers 32 are operated to provide air through the pleated conduit tubes as described above. Negative pressure is provided in the floor plenum 66 by operation of the suction blowers 72. The indirect evaporative coolers 42 and blowers 44 are also operated to cool the growth chamber even during winter due to the heat generated by the birds during this last growth cycle. The forced air aids in maintaining positive pressure in the growth chamber for forcing maximum flow of air downwardly through the manure which may have collected to a depth of one and one half inches or more resting on top of geotextile carpet 65.

It should be understood that external conditions, such as temperature and humidity variations, might require adjustments of one or more of the environmental controls for the growth chamber during this or any of the other growth periods.

At the end of the growth period the chicken harvesting is begun. The lower ends 36 of the pleated conduit tubes 34 are lifted out of the floor plenum and to a height sufficient to permit them to clear the upper extent of moveable wall 27, and to allow workers and equipment to move freely in the growth chamber. Side gate 35 is also lifted to its elevated position. The power-driven winches connected to pusher wall 27 are then activated for initiating the very slow movement of pusher wall 27 toward conveyor upper flight 19. Additional mechanisms to move the birds toward conveyor upper flight 19 are light beams and sound signals to which the birds have been conditioned for movement toward flight 19.

Pusher wall 27 consequently acts to gently urge and carefully nudge the chickens onto upper flight 19 of conveyor 29. The foregoing movement of pusher wall 27 requires approximately four hours to complete the harvesting procedure (for a chicken house approximately 30 feet wide) during which time conveyor 29 is activated to move the fowl to the downstream end of the conveyor external of the growth chamber 11 where the fowl are then placed in cages for transport to a processing facility.

Upon completion of evacuation of the fowl, the dried manure on the upper surface of ventilated floor assembly 16 or 98 is blown on to upper flight 19 of the conveyor 29 by use of snow blowers or the like, and the conveyor 29 thus removes the dry manure from growth chamber 11. In the absence of conveyor 19, the dry manure can simply be vacuumed up.

It is also contemplated that ultra-violet light will be used in the growth chamber 11 for destroying salmonella, E-coli, coccidiosis, and multiple bacteria strains and fungus/mold during the chicken growth period as it develops, and in a final cleaning procedure following removal of the chickens and dry manure from the growth chamber. One such system and method is disclosed and claimed in co-pending application, filed on Jun. 1, 2005, entitled “System and Method for Providing Germicidal Lighting for Poultry Facilities” (Attorney Docket No. P69532US1), owned by the same assignee, the disclosure of which is expressly incorporated in this application as if fully set forth herein.

As is evident from the foregoing description, the previously described active embodiments of the present invention rely on air blowers or exhaust fans that create a pressure differential as between the growth chamber and the floor plenum that cause air to be drawn downwardly from the growth chamber through the ventilated floor and into the plenum. However, it has been discovered that the ventilated floor assembly of the present invention can be very effective in drying the manure retained on top of the ventilated floor without the need for air blowers or exhaust fans to be connected with the floor plenum to draw air through the floor. Rather, such a passive embodiment relies on the creation of a negative pressure differential as between the inside of the growth chamber and the outside environment. This negative pressure differential is created by the already existing practice of tunnel ventilation air flow through the length of the chicken house. By using air blowers or exhaust fans in one end wall of the chicken house to expel air out of the one end, a negative pressure is created in the growth chamber. This negative pressure causes air intake flap openings, cold water cooling pads or other negative pressure-operated openings in the other end wall to open, thus drawing air from the outside environment to flow into the chicken house.

The air plenum of the ventilated floor assembly is vented directly to the growth chamber, thus serving to equalize the negative pressure both above and below the ventilated floor and the manure retained thereon. While the air vents between the growth chamber and the floor plenum are preferably located along the sides of the chicken house and along the crown or crowns of the ventilated floor assembly, as will be described hereinafter, the plenum venting can be located at any convenient location or locations through or around the ventilated floor. With the negative pressure both above and below the retained manure, the moisture in the manure is continuously being evaporated into the air of the chicken house along both the top and bottom surfaces of the manure. Once airborne, the moisture is expelled out of the chicken house by the tunnel ventilation air flow. This continuous evaporation of the moisture in the manure and its removal from the chicken house by the tunnel ventilation serves to dry the manure to a desired moisture content, preferably between about 20% and about 30%. It has been found that moisture levels below 20% are not desirable because at this low level of moisture dust is created which can become airborne. Moisture levels substantially above 30% allow for too much water content in the manure, thus elevating its pH level and causing ammonia formation.

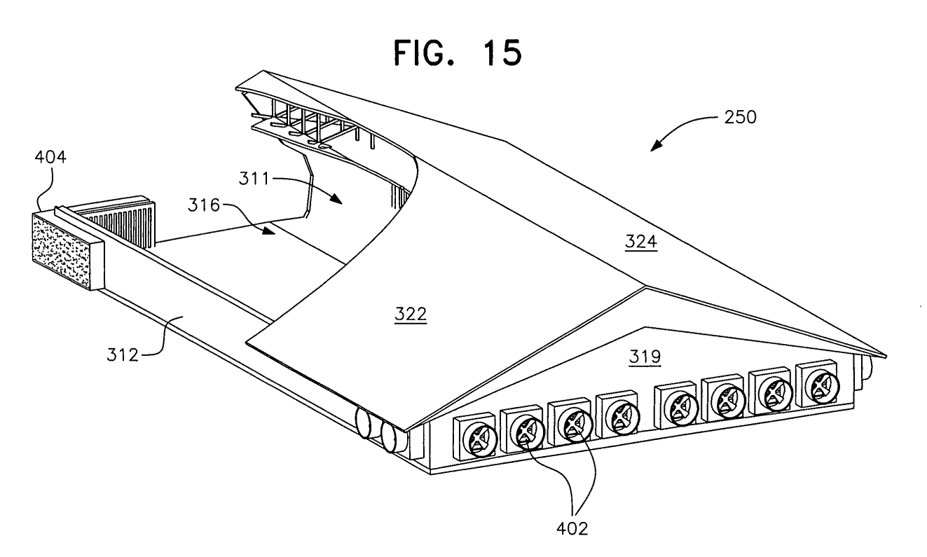

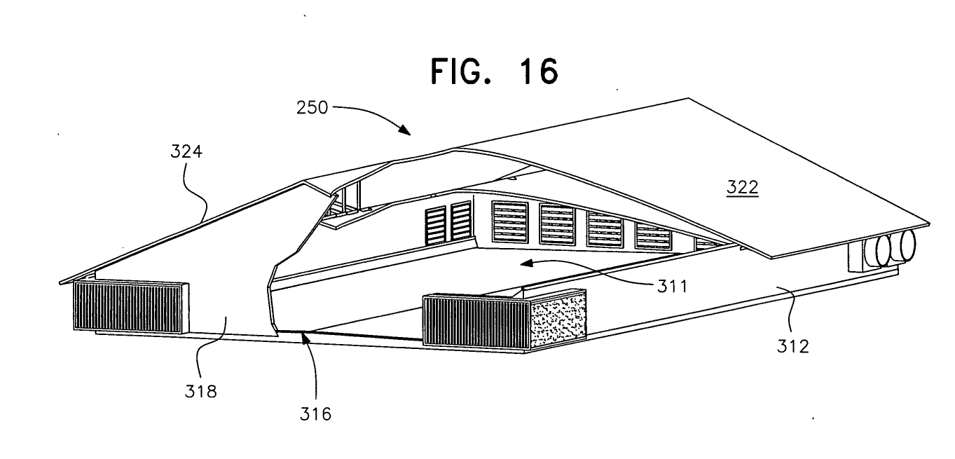

A chicken growth facility or chicken house in accordance with the above-described passive embodiment of the present invention is shown in FIGS. 15-18 and generally designated by reference numeral 250. As with the active embodiments, the chicken house 250 can be either a newly constructed chicken house equipped in accordance with the present invention or an existing structure which is renovated and partially reconstructed, i.e., retrofitted, to incorporate the apparatus and method of the passive embodiment of the present invention.

The chicken house 250 provides an elongated growth chamber, generally designated by reference numeral 311 and generally defined by a left side wall 312, a right side wall 314, a rear wall 318, a front wall 319, and left and right ceiling panels 322 and 324, which are connected in a generally A-frame configuration. Exhaust fans 402 are mounted in the front wall 319 at one end of the chicken house 250, and cooperating inlet flap openings or cold water cooling pads 404 are mounted in the rear wall 318 at the opposite end of the chicken house, as is conventional in the industry. As is also known by those skilled in the art, the exhaust fans 402 are not operated continuously. Rather, the exhaust fans typically commence operation automatically when either the humidity (in the winter) or the temperature (in the summer) reaches designated undesirably high levels in the growth chamber. Upon reaching such a predetermined level, the exhaust fans commence operation, thus creating the negative pressure in the growth chamber, and the floor assembly plenum through the plenum vents, thus opening the air intake flaps 404. The exhaust fans typically operate for about 5-10 minutes to reduce the humidity or temperature, as the case may be, to a desired level in the growth chamber and then the fans stop until the undesirably high condition level is again reached to initiate fan operation. This cycling on-and-off of the exhaust fans 402, and the consequent creation of a reduced pressure in the growth chamber and floor plenum causes the undesired moisture in the manure to be continuously evaporated, thus maintaining a desired moisture content of between about 20% and about 30%, by which the manure would be “dry” to the touch.

Further, by achieving the aforesaid moisture level in the range of between about 20% and about 30%, the pH of the manure is kept below 7.0, and preferably is between about 5.0 and about 6.0. By maintaining the moisture and pH levels of the manure within these ranges, the growth of pathogens and intestinal parasites in the manure such as coccidiosis is prevented. In addition, both mold and bacteria growth is reduced and the production of ammonia and methane gas is largely prevented.

The passive system as shown in FIGS. 15-18 employs a ventilated floor assembly similar to those previously described and is generally designated by reference numeral 316. The floor assembly 316 rests on a plastic liquid and vapor barrier 360, which comprises a barrier below the floor assembly 316. In this embodiment, a layer of gravel, crushed stone or other compressible material 361 is laid under the plastic vapor barrier 360 and over the ground surface 363. The substrate layer 361 provides a stable support surface for the floor assembly when the chicken house is constructed over soft or shifting soils that might move under vehicular traffic.

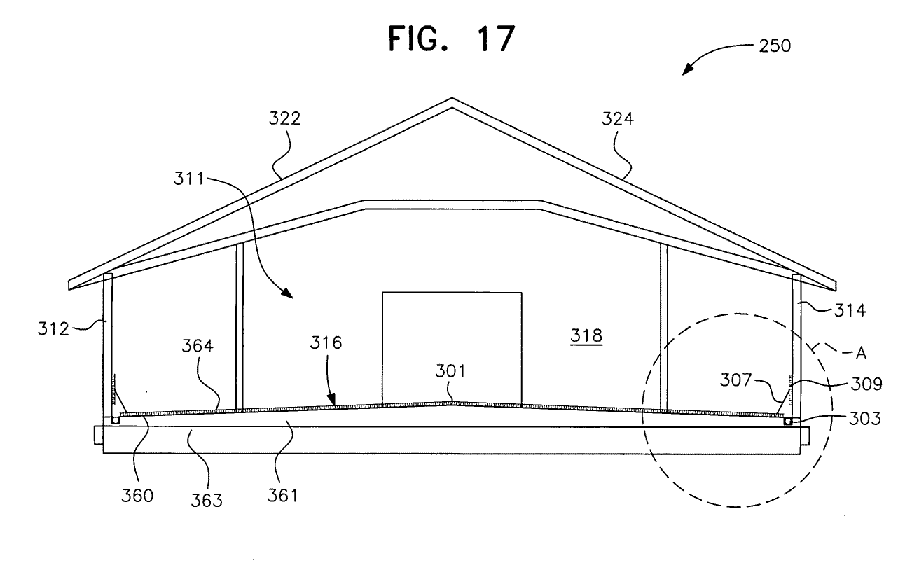

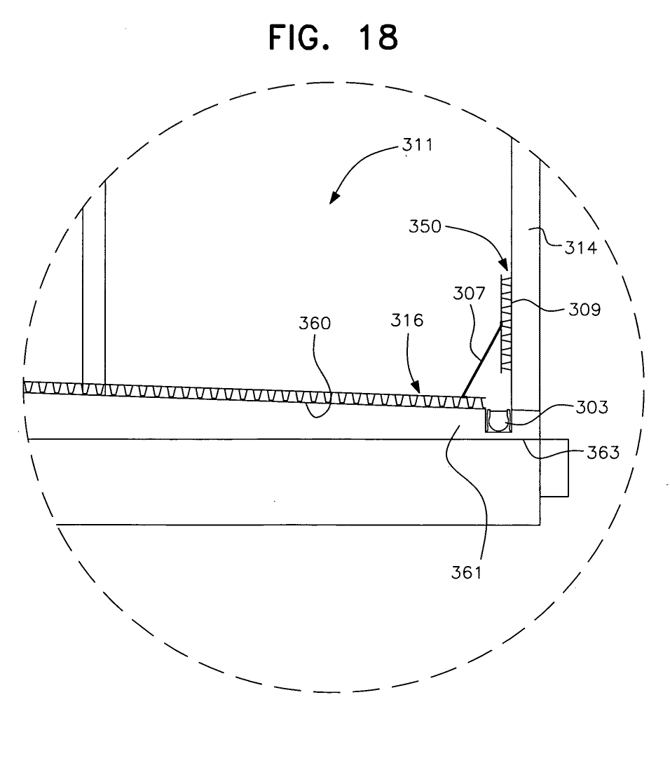

As shown in FIGS. 17 and 18, the ventilated floor 364 of the ventilated floor assembly 316 in this embodiment is divided along a center line 301 that runs the length of the house, with each half of the floor sloping downwardly from a crown at the center line 301 toward the sides 312, 314 of the house. The slope of each side of the floor is preferably between about 1° to about 5°, and more preferably about 2°. Each side 312, 314 of the house is provided with a plurality of drains 303 with associated catch basins (not shown) to collect and pump off cleaning water. Preferably there is a drain 303 located about every 100 feet along each side.

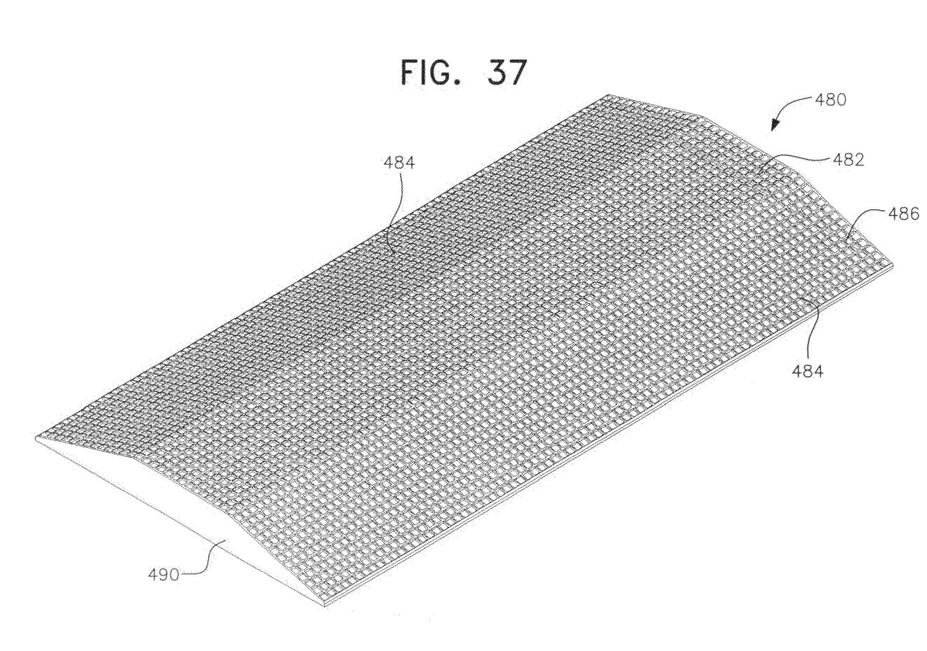

While the chicks are present in the growth chamber 311, the chicks are protected from falling into the drains by the placement of sloped plastic sheeting 307, such as 8 mil polyethylene sheeting, or similar material that extends from the floor upwardly to a suitable height along the side walls. The sheeting 307 is secured to a line of wall components 309 that are attached to the studs of side walls 312, 314, which together form the plenum vents 350 that extend the full length of the growth area 311 (see FIGS. 18 and 36). As depicted in FIGS. 18 and 36, the wall components 309 are formed by side-by-side ventilated floor assemblies 316. After the chicks have grown to the harvesting stage and have been removed from the house, the slope of the floor and interconnected bottom plenum assist in washing down the floor and collecting and pumping off the cleaning water so that the underlying ground is not saturated with the run-off when preparing the house for the next flock of chicks.

While the floor 364 is shown in FIG. 17 with a single crown at the center line 301 with each half of the floor sloping downwardly from the center line toward the sides 312, 314 of the house, it should be understood that the floor could be configured with a plurality of crowns and valleys, especially in extra-wide chicken house structures. For example, the floor could have a crown at the center line which slopes downwardly along each side to a valley located a specified distance from the center line and the floor then sloping upwardly until it reaches the sides 312, 314. In another configuration, the floor could have two crowns generally positioned inwardly one-quarter of the distance between the side walls 312, 314, with the floor sloping downwardly from each crown to form a valley generally at the center line, while the opposite sides of the flooring from the crown slopes downwardly to the sides 312, 314. Obviously, other configurations of alternating crowns and valleys can be designed, as desired. In each configuration, however, the slope of each floor segment from the crown to the valley should preferably be within the angles described above.

As in the active embodiments, the passive embodiment of the present invention utilizes a ventilated floor assembly 316 which extends over the entire floor of the growth chamber 311. With respect to the specific construction of the floor assembly 316, many of the components are the same as in the active embodiment already described in connection with FIGS. 8-14. Therefore, the present description will focus on particular aspects of floor assembly 316 which differ from floor assembly of FIGS. 8-14, so as to avoid repetition of the common aspects already fully described.

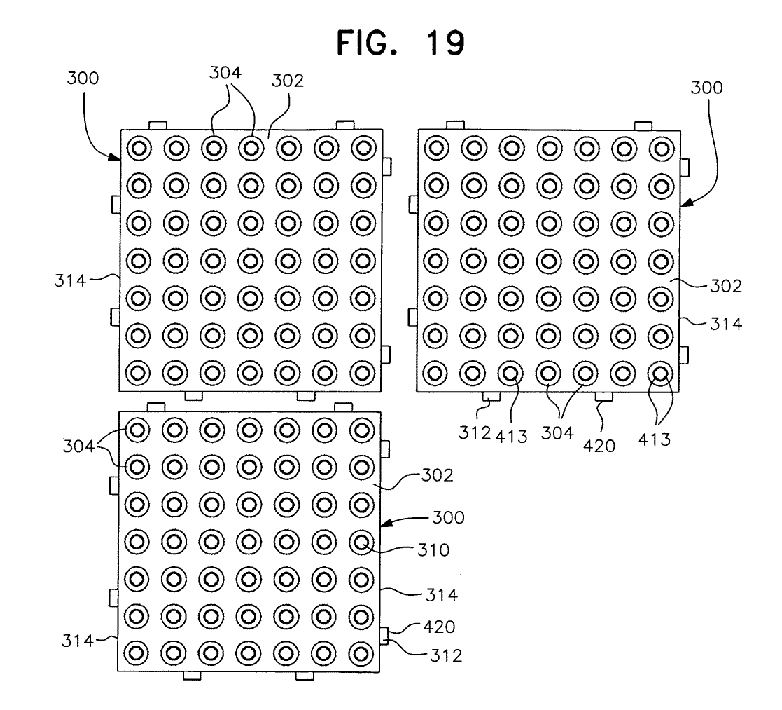

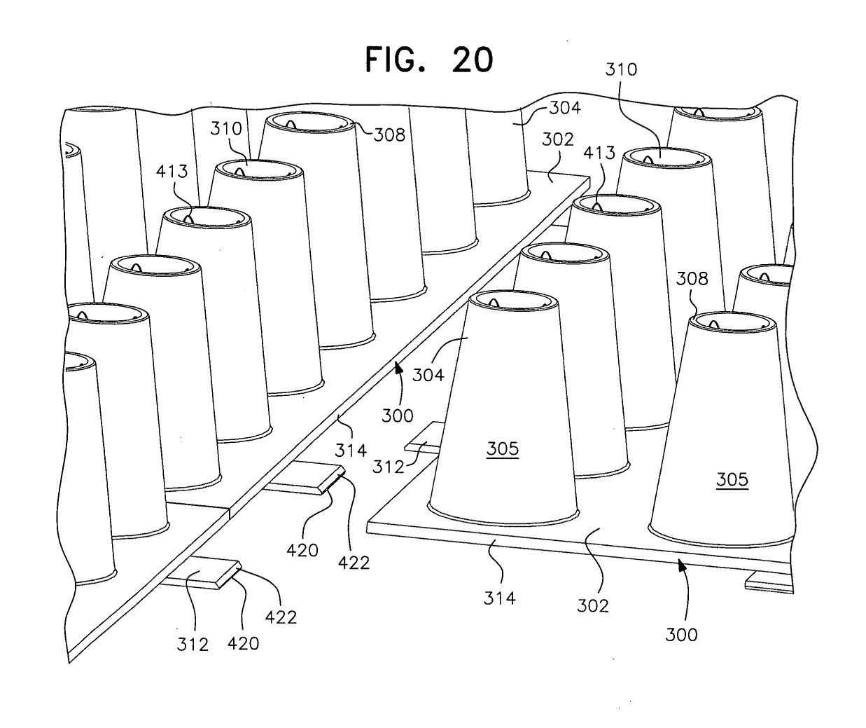

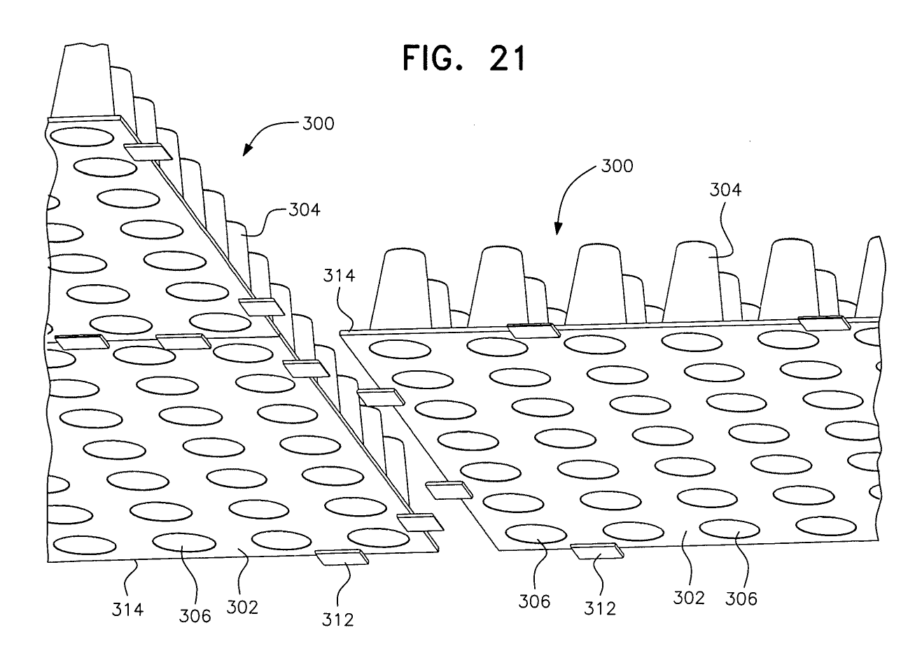

As in the prior embodiment, the floor assembly 316 includes a plurality of bottom floor modules generally designated by reference numeral 300 and a plurality of ventilated modular floor sections generally designated by reference numeral 320. Each bottom floor module 300 includes a flat base component 302 and a plurality of upstanding hollow support elements or spacers 304 that are preferably cone-shaped and which, from the bottom thereof, taper upwardly to the top as shown in FIGS. 19-22. The cone-shaped support elements are hollow with a generally smooth outer surface 305, a circular opening 306 at the bottom and a circular opening 310 at the truncated top. The support elements 304 are truncated at the top to provide a flat upwardly facing support surface 308 for the floor sections that interlock and rest thereon when the floor is assembled.

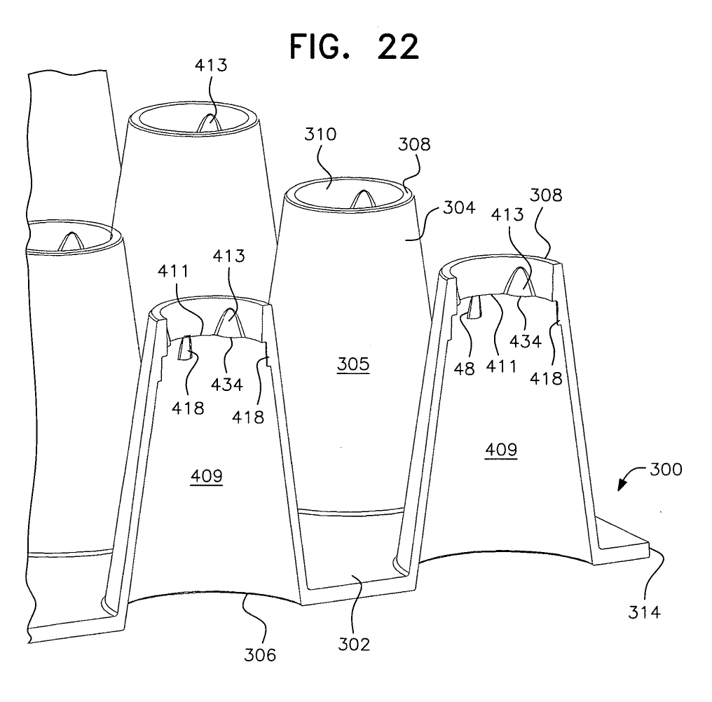

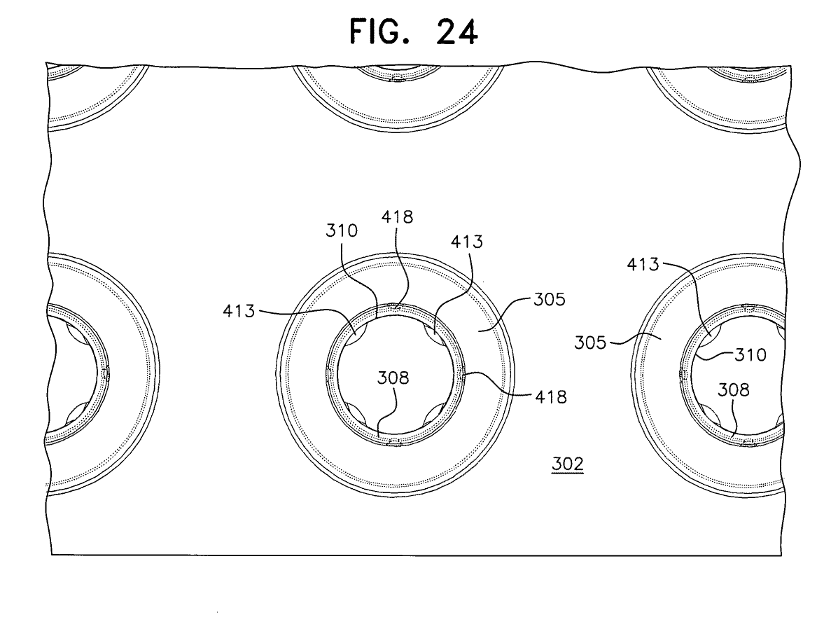

An inwardly projecting ledge 411 is formed on the inner surface 409 of the support elements 304 near the truncated tops (see FIG. 22). The ledge 411 preferably extends around the inner circumference of each support element and includes one or more inwardly projecting flanges 413 that provide an engagement surface 434 when interlocked with the floor sections as will be described further hereinafter. There are preferably at least two and more preferably four flanges 413 which are preferably evenly spaced from one another around the ledge circumference as shown in FIGS. 19, 23 and 24.

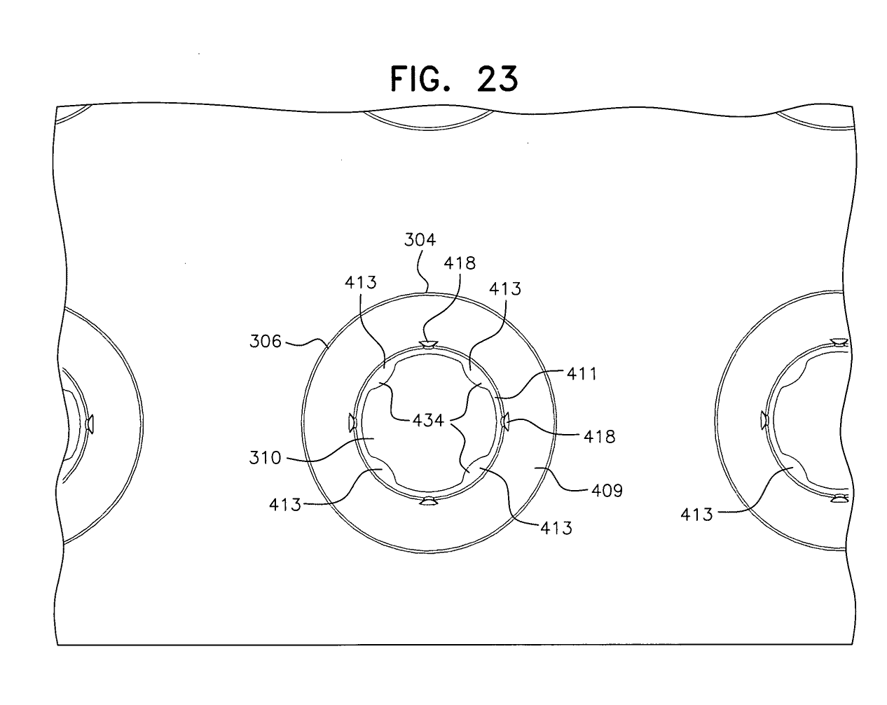

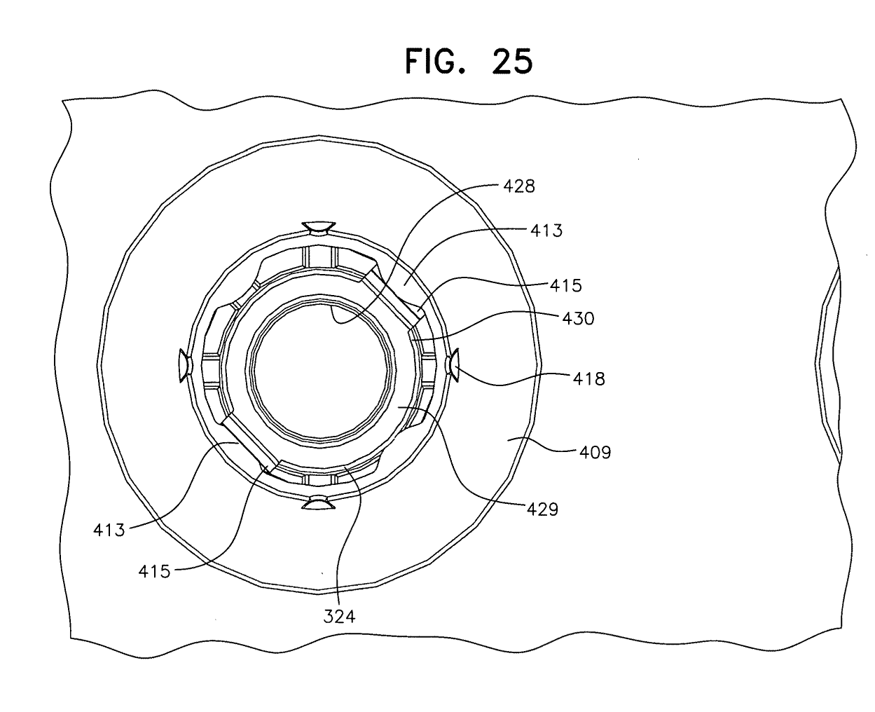

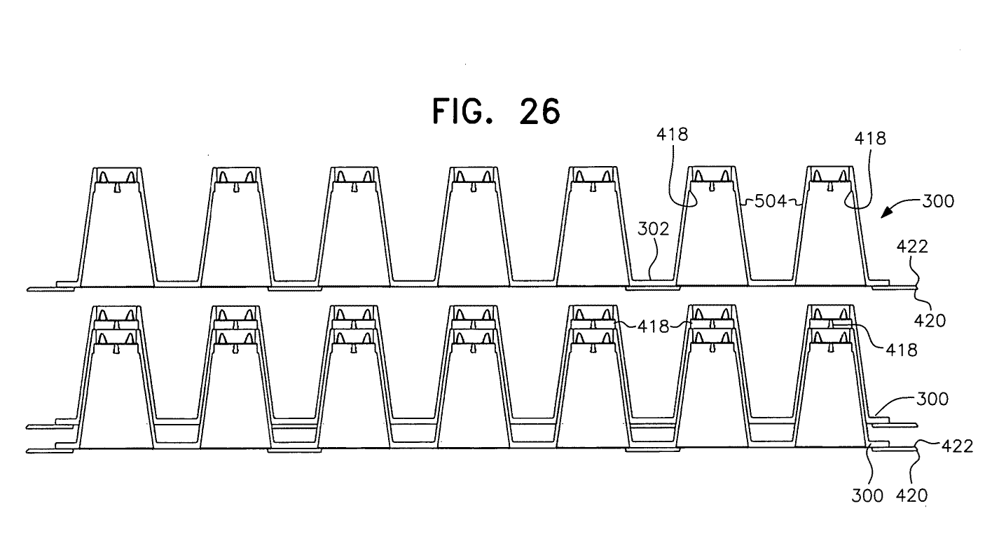

The inner surface 409 of the support elements 304 further includes a plurality of tabs 418 near the truncated tops that extend substantially vertically from below the ledge 411 toward the opening 306 at the bottom of the module 300. The tabs 418 are preferably evenly spaced from one another around the circumference of the inner surface 409 of the support elements 304. As best seen in FIGS. 23-25, there are preferably four tabs, although two, three or more than four tabs could be included. As shown in FIG. 26, the tabs 418 allow the bottom floor modules 300 to be stacked one upon another during storage and shipment without becoming wedged together, thus allowing for easier separation of the modules from a stacked configuration.

As in the prior embodiment, the unitary bottom floor modules 300 also include interlocking elements 312 along the side edges 314 of each flat base component 302, see FIGS. 19-21. According to one preferred embodiment, each floor module has two interlocking elements 312 along each side edge. When the bottom floor modules are placed side-by-side on the ground, the interlocking elements 312 of one base component slide under the adjacent base component 302, allowing the side edges 314 of two adjacent floor modules to be brought into abutment with one another. To facilitate this sliding action, the outer edges 420 of the tabs 312 have a beveled surface 422. When the floor modules are interlocked in this manner, the flat base components 302 of the modules 300 cover the entire ground surface 363 under the growth chamber 311. A plastic vapor barrier 360, such as polyethylene sheeting, is placed between the modules 300 and the gravel, crushed stone or other compressible material layer 361. As described previously, the interlocked floor assembly 316 together with the sheeting 360 acts as a heat transfer insulator, minimizing the ground as a heat sink in warm weather and reducing any moisture transfer from the ground in cold weather.

As in the prior embodiment, the plurality of ventilated modular floor sections 320 make up the ventilated floor 364. The floor sections have the same rectangular size and shape, preferably square, as the base 302 of the bottom floor modules 300. Other polygonal shapes could also be employed provided such shapes would allow for a solid interlocking floor 364 without gaps.

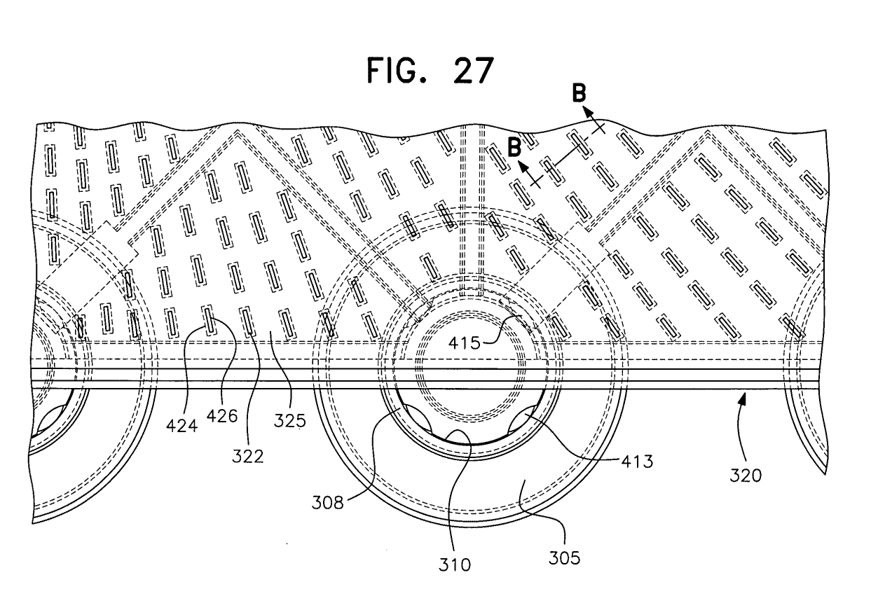

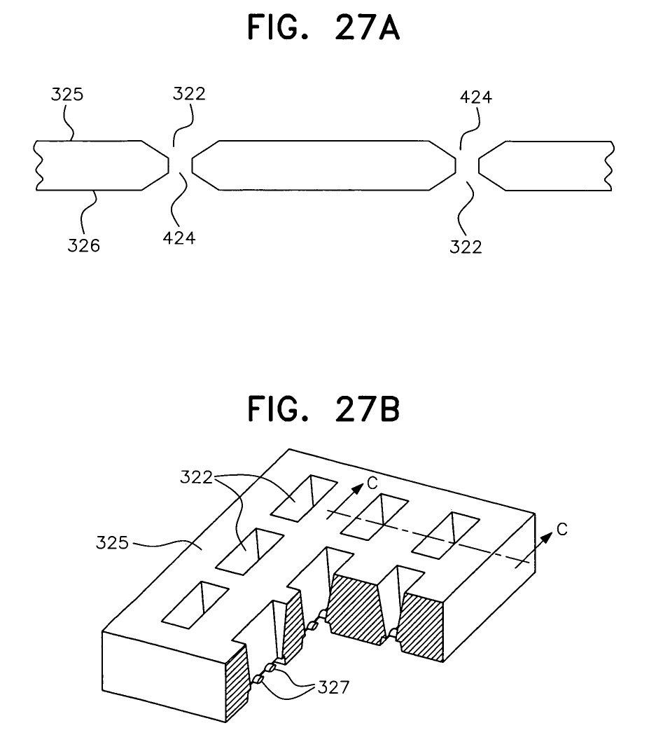

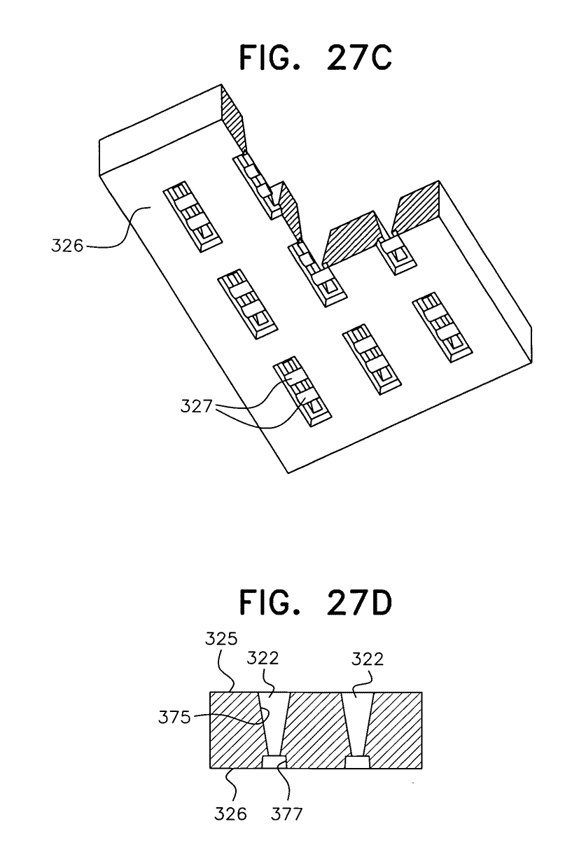

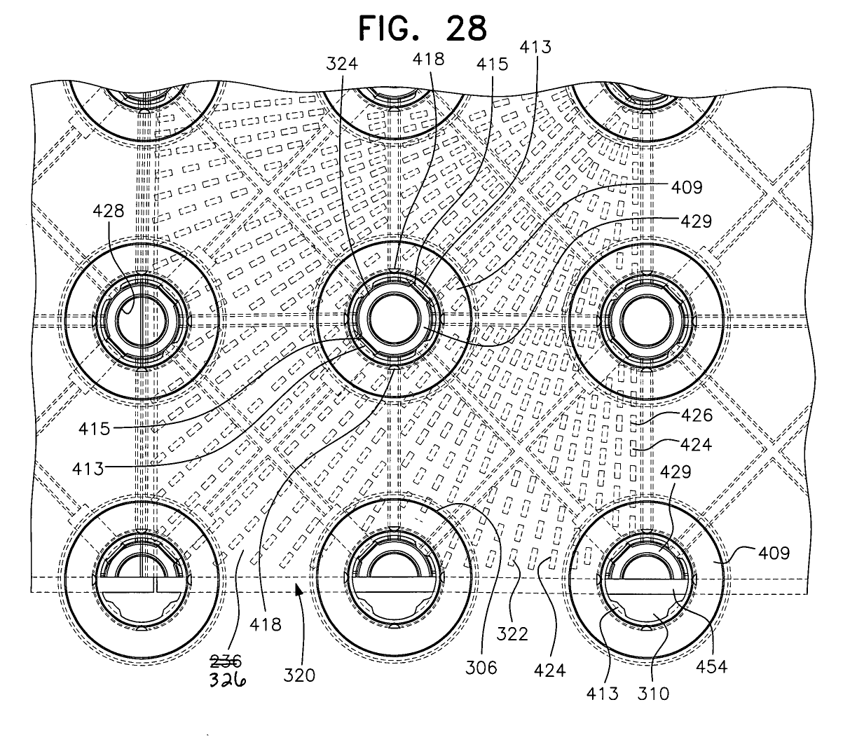

Like the bottom modules 300, the rectangular floor sections 320 are injection molded of a suitable polymeric material and include a flat upper surface 325 having a large number of small holes or openings 322 extending completely therethrough as shown in FIGS. 27, 27A, 27B, 27C and 27D. The openings 322 are sized to allow air and other gases, including moisture, to pass therethrough while retaining manure and other solids on the upper surface 325 of the floor 364. According to a preferred embodiment, these openings are preferably formed as slots, although the shape of the openings is not critical as they can be round, square, triangular, or any other polygonal or other shape. Whatever their shape, it has been found that the total area of the openings should make up about 2% to about 25% of the total floor area, more preferably about 3% to about 12% of the total floor area, and most preferably about 4% to about 6% of the total floor area.

As shown in FIG. 27A, the slotted openings 322 can be tapered inwardly from the top and the bottom equally toward the center so that the size of the openings on the upper surface 325 and the size of the openings on the lower surface 326 is somewhat larger than the size of the openings at the center 424. The openings 424 preferably have a width of between about 0.020 and about 0.025 inches, and a length of between about 0.125 inches and about 0.200 inches, although the slot length could be as long as about 1.0 inches. This inward tapering can provide for better retention of the manure on the upper surface 325 of the floor section 320 and for better moisture evaporation of the manure moisture into the air in the growth chamber and in the floor assembly plenum.

Another slot configuration is shown in FIGS. 27B, 27C and 27D. In this embodiment, the slots 322 have a much longer taper 375 from the top surface 325 and a much shorter taper 377 from the lower surface 326 (see FIG. 27D). As shown in FIGS. 27B and C, the slots 322 can include ribs 327 which extend laterally across the slots in the plane where the taper 375 from the upper surface 325 converges with the taper 377 from the lower surface 326.

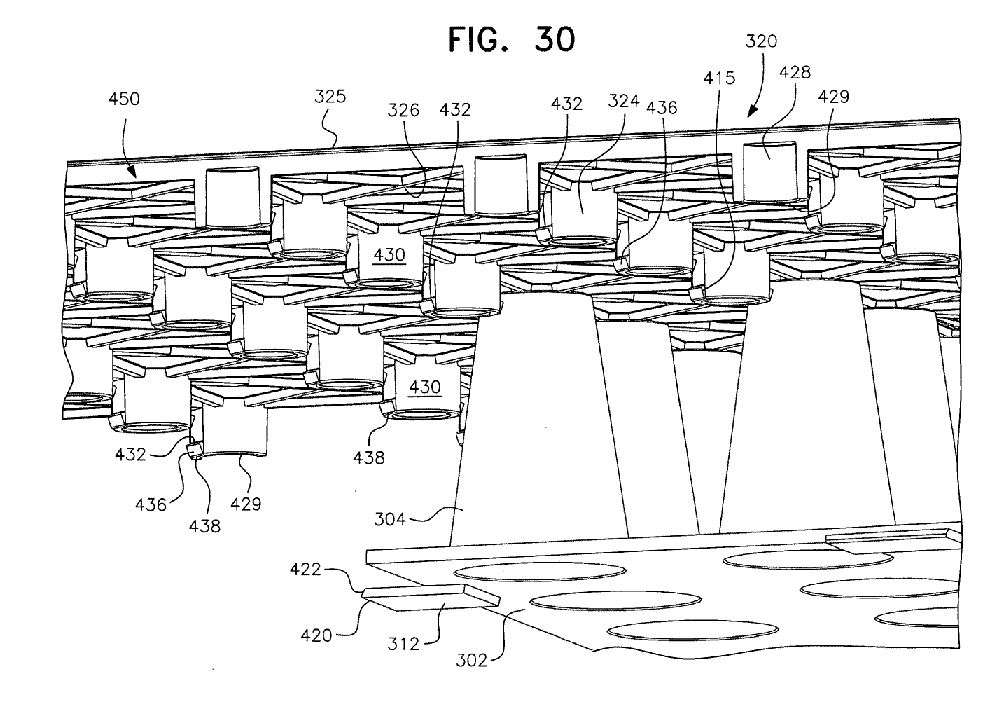

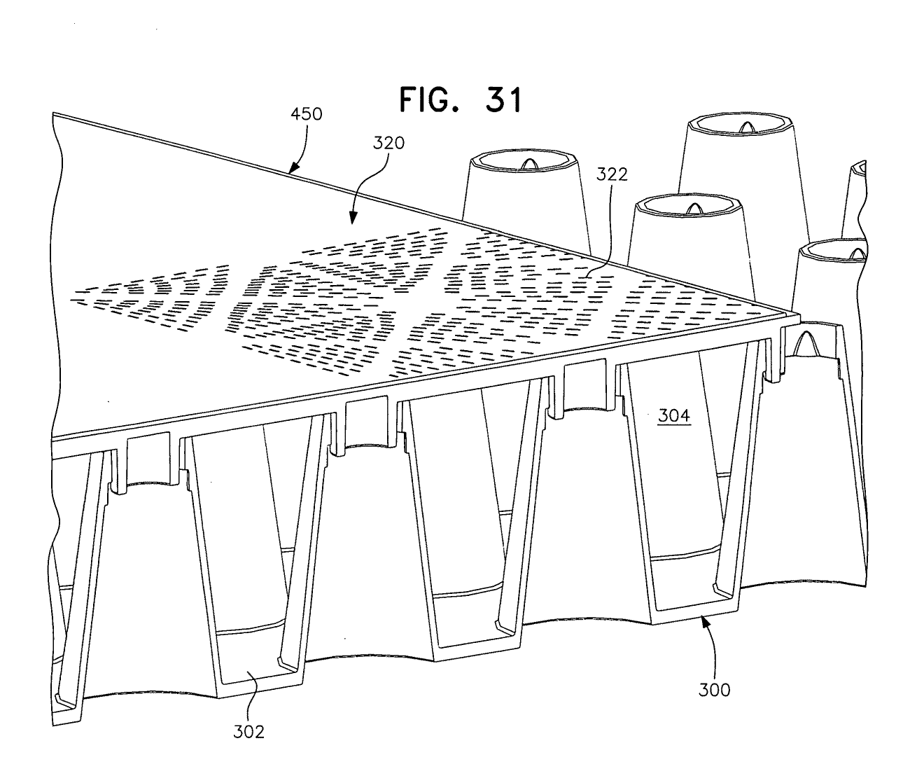

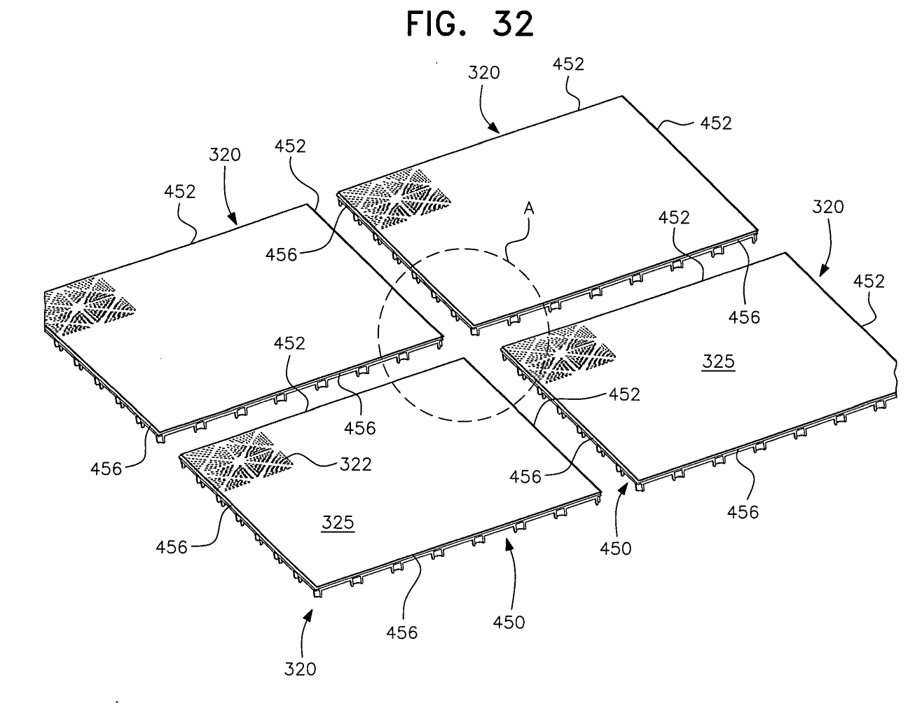

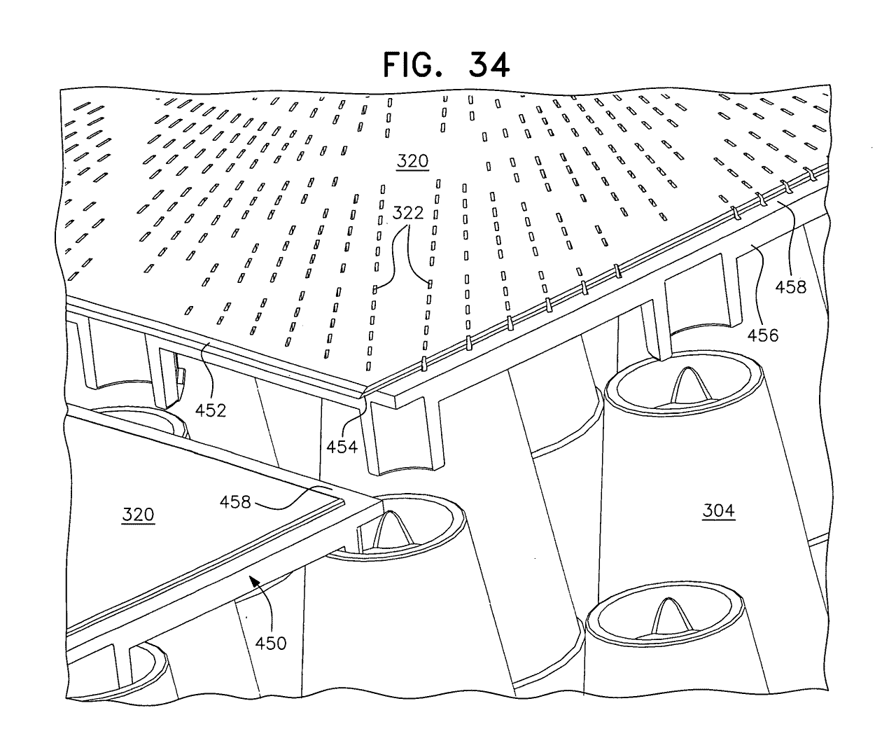

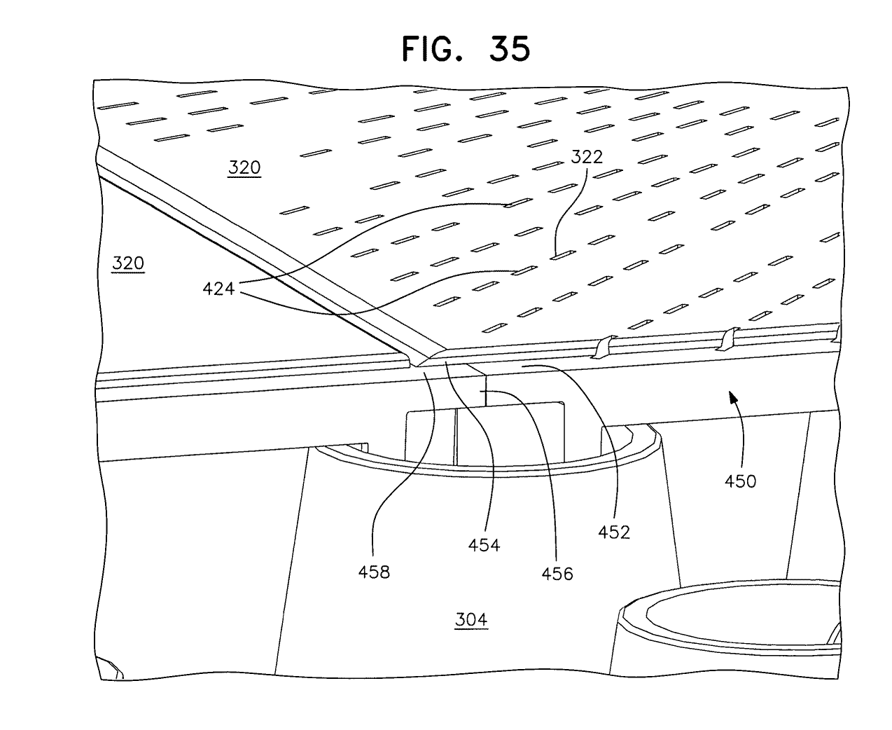

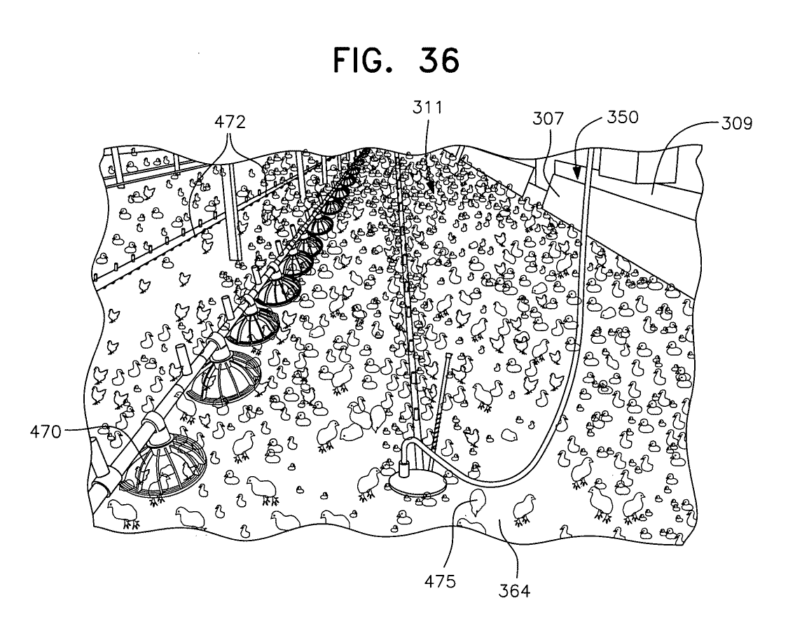

As shown in FIGS. 29-35, the floor sections 320 also include cylindrical projections or bosses 324 which extend from the lower surface 326. The outer diameter of the bosses 324 are sized to snugly fit within the circular openings 310 in the tops of the support elements or spacers 304. To provide a snap-in fit, the outer surface 430 of each of the bosses 324 adjacent the edge opening 429 of the bore preferably includes at least one outwardly projecting tooth 415. The tooth 415 has a substantially flat upper locking surface 432 that is in abutment with the engagement surface 434 of the corresponding flange 413 on the support module ledge 411 when the floor section is snap-fit to the bottom module 300. The side 436 of the tooth 415 tapers downwardly from the locking surface 432 toward the bore edge opening 429 so that the bottom 438 of the tooth 415, which is adjacent the bore edge opening 429 in the boss 324, is smaller than the top of the tooth adjacent the locking surface 432. This taper facilitates insertion of the boss 324 into the circular openings 310 of the support elements 304. According to the preferred embodiment shown, each bore has a pair of teeth 415 diagonally positioned on either side of the bore 428. The number of teeth and the number of flanges may be varied, so long as complementary component types are positioned relative to the other to allow for snap-fit interlocking engagement between the bottom modules 300 and the floor sections 320 when the floor is assembled (see FIGS. 29-31).

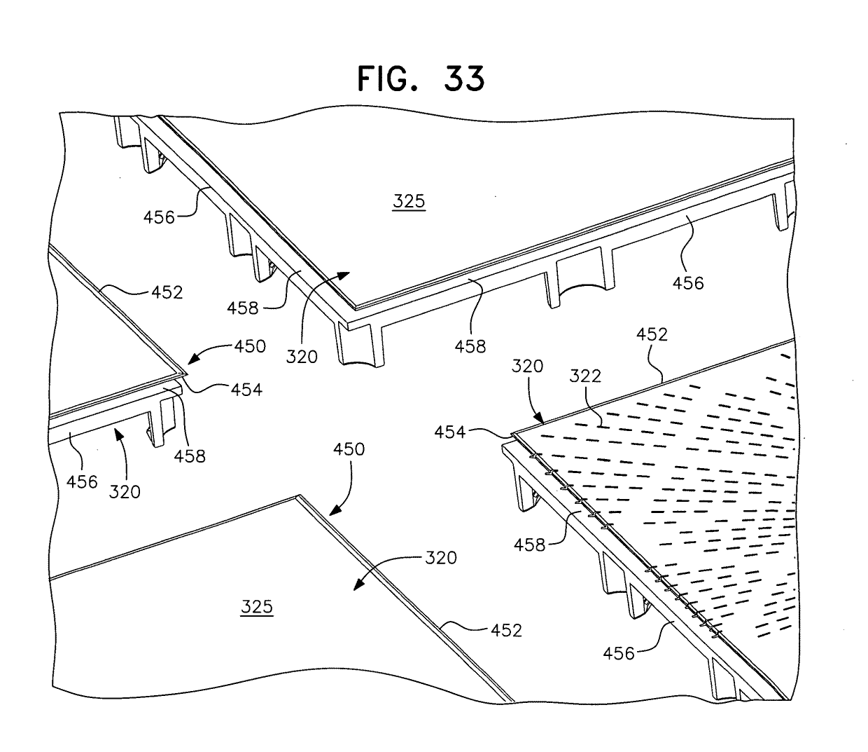

As best seen in FIGS. 32-35, the side edges, generally designated by reference numeral 450, of the floor sections 320 are configured to overlap in either an upper position or a lower position relative to adjoining floor sections. More particularly, each floor section preferably includes two adjacent side edges 452 having projecting ledges 454 and two adjacent side edges 456 having supporting shelves 458. When the floor sections are assembled with one another and with the bottom modules, the floor sections are positioned so that the side edges 452 having ledges 454 are in abutment with the side edges 456 of adjacent sections having shelves 458 so that the ledges 454 take an upper position in overlapping with the shelves 458 and, conversely, the shelves 458 take a lower position in overlapping with the ledges 454. The overlap accommodates expansion and contraction of the floor sections 320 due to temperature and humidity changes, or otherwise, and ensures that no cracks are formed between the floor sections that could catch the chicks' feet or through which manure could pass into the plenum.

When the ventilated floor assembly 316 is installed, the interlocked bottom modules 300 and floor sections 320 provide a very strong assembly with a smooth ventilated upper surface that is able to support vehicular traffic. When the chicken house is cleaned in between flocks, the cleaning crew can drive onto the floor assembly with pick-up trucks, tractors, etc. The floor when properly installed as described herein can hold approximately 300 pounds per square inch, and perhaps more.

While the ventilated modular floor sections 120 and 320 of the previously described embodiments preferably include a large number of small holes 122 or small slots 322 extending completely therethrough, other configurations for the ventilated modular floor sections are possible without departing from the present invention. Specifically, the holes 122 or slots 322 could be sized and filled with an air and moisture permeable polymer or other material which provides for the necessary air and moisture flow downwardly from the manure (feces) retained on the upper surface of the floor sections and into the air plenum underneath the floor sections. The size and shape of the holes 122 or slots 322 along with the type of air/moisture permeable polymer or other material must also be selected so that the polymer or other material is retained in the holes or slots during use of the ventilated floor assembly in the chicken house or other fowl growing facility.

Another modified configuration for the ventilated modular floor sections 120 and 320 would be to actually mold or make the floor sections of an air and moisture permeable polymer or other material. The polymer or other material must have sufficient air and moisture permeability so as to provide necessary air and moisture to pass therethrough and into the air plenum in order to dry the manure retained on its upper surface to the desired moisture content between about 20% and about 30%. The floor sections of such permeable polymer or other material would also have to have sufficient strength so as to withstand and support the vehicular traffic utilized in conventional chicken houses and other fowl growing facilities. Such air/water permeable polymer or other material could include properly supported geotextile carpets and the like previously described in connection with the present invention.

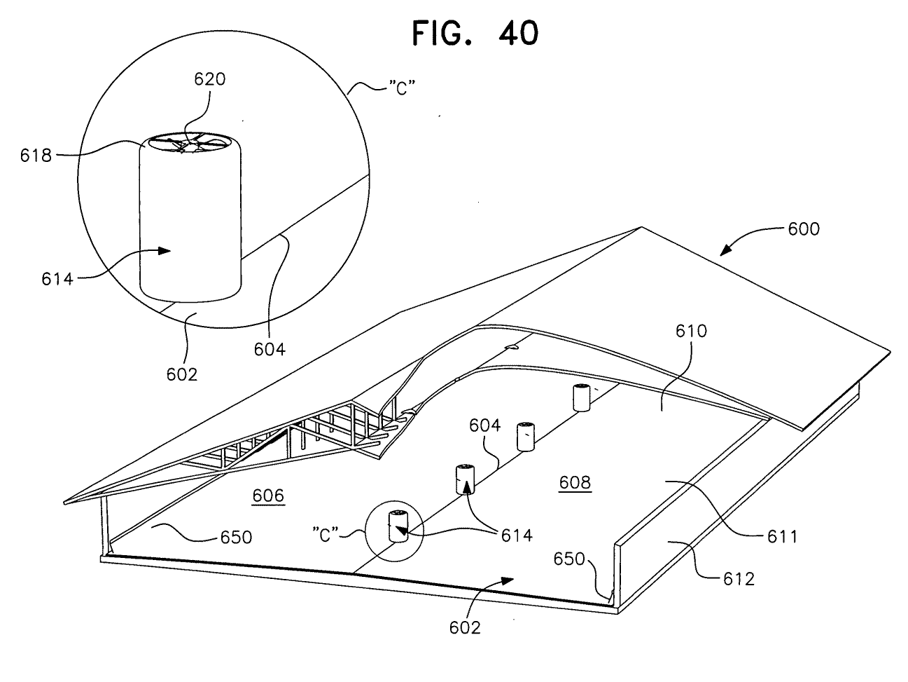

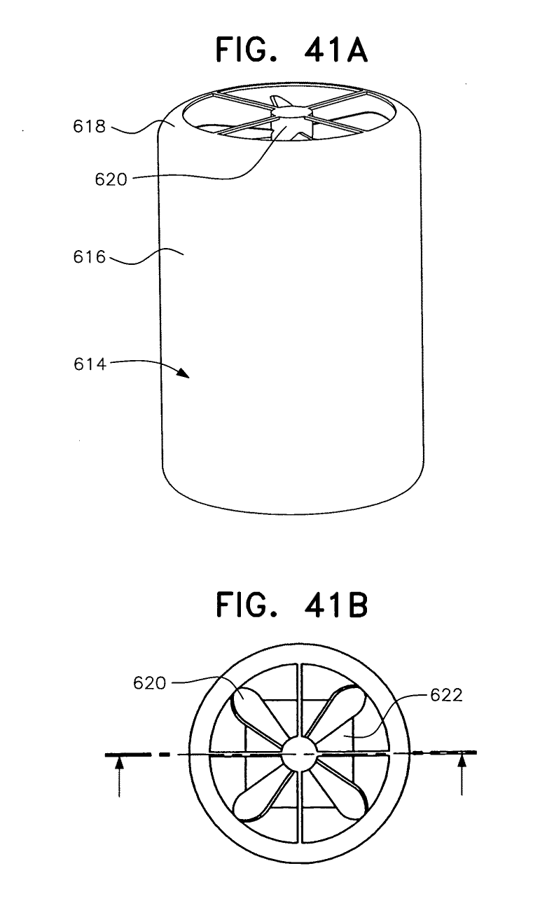

Also, as will be understood by those skilled in the art, the dried manure (feces) retained on the upper surface of the ventilated modular floor sections 120 and 320, will tend to clog the small holes 122 and slots 322, respectively, as the manure piles up on top of the floor sections. Once the holes or slots become clogged with dry manure, air may not pass through the holes or slots into the air plenum below the floor sections, although the flow of moisture will continue. However, the make up of the air and the air pressure in the air plenum is equalized to that in the growth chamber by the air flow through the side plenum vents 350, and side plenum vents 550 and 650 as described hereinafter in connection with embodiments shown in FIGS. 39 and 40. As also described in connection with those latter embodiments, airflow between the air plenum of the ventilated floor assembly and the growth chamber is also achieved through vertically extending exhaust pipes 514 and vertically extending exhaust fans 614.

As is known, feeding stations 470 and water dispensers 472 are spaced throughout the growth chamber 311 as shown in FIG. 36. The chicks 475 congregate around these units to eat and drink so that more urine is excreted in these areas. In the case of the water dispensers 472, this excess urine in combination with any water that may be spilled creates an increased moisture content in the feces that can cause a basic or alkaline condition under and around the water dispensers. While the present invention is intended to function well without the use of bedding, the feet of new chicks must be protected in these areas of higher alkaline conditions. This protection may be provided through the spreading of a thin layer of wood shavings or chips on the upper surface of the floor underneath the water dispensers. Once the chicks have grown sufficiently to develop natural callouses on their feet, generally after about 2-3 weeks, the wood chips are no longer necessary.

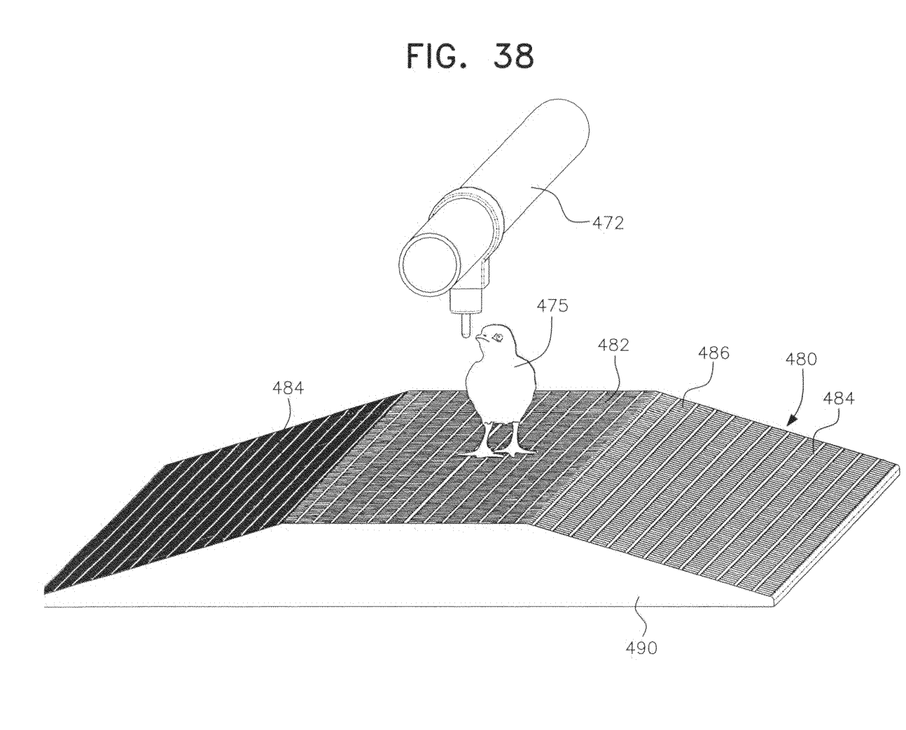

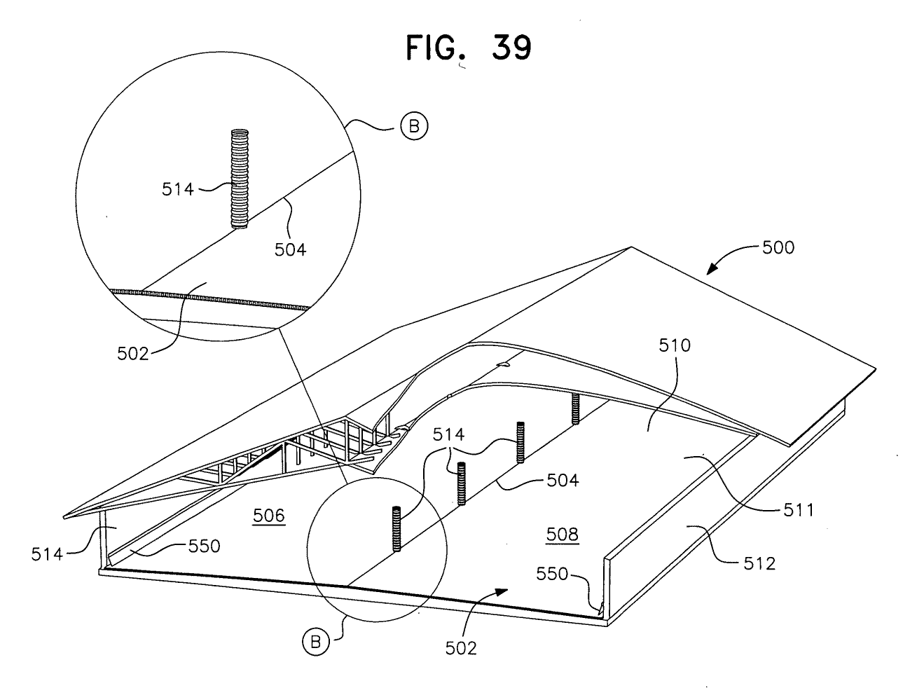

According to a preferred embodiment directed to protecting the feet of young chicks from the alkaline effects of the flooring underneath and around the water dispensing nozzles, the floor 364 is preferably provided with one or more layers of a polymer grid material, such as a high density polyethylene (HDPE) or polypropylene grid, generally designated by reference numeral 480 as shown in FIGS. 37 and 38. The grid layers positioned underneath the nozzles are preferably configured as a “mound”, having a generally flat upper surface 482 and tapered sides 484 to allow the chicks to walk up and down. The polymer grid material 480 can be supported in the mound configuration by suitable wood supports 490, or the polymer grid material can be formed, such as by injection molding, into a self-supporting mound shape. The openings 486 in the grid 480 can range from about ¼ inch to about ¾ inch, preferably inch, through which gas and liquid can easily pass so that the grid 480 provides for effective drainage of moisture away from the area immediately beneath the water dispensing nozzles.

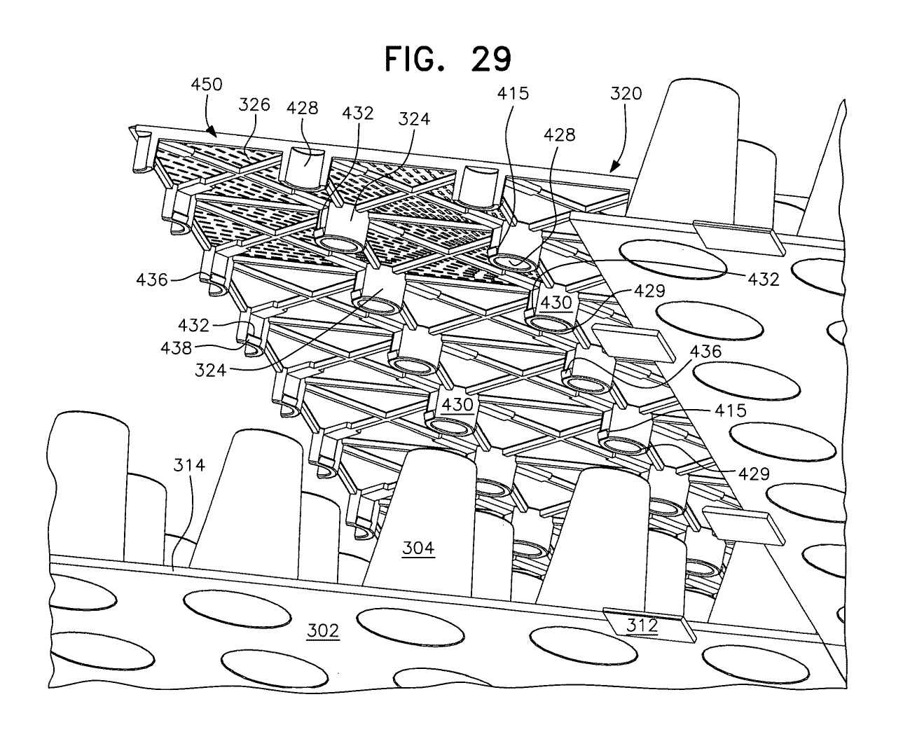

Turning now to the embodiment of the invention illustrated in FIG. 39, a conventional chicken house, generally designated by reference numeral 500, includes a passive ventilated floor assembly 502 in accordance with the present invention incorporated therein. The ventilated floor assembly 502 is substantially identical to that previously described for floor assembly 316 in the embodiment illustrated in FIGS. 15-38. Thus, the ventilated floor assembly 502 includes a crown along the center line 504, with each half 506, 508 of the ventilated floor 510 sloping downwardly from the center line 504 to the sides 512, 514 of the house. Side plenum vents 550 extend the full length of the chicken growth area 511 so as to provide direct venting of the air plenum of the ventilated floor assembly 502 directly to the growth chamber 511.

The difference between the passive ventilated floor system of FIG. 39 and that disclosed in FIGS. 15-38 is the inclusion in the former of a series of vertically extending exhaust pipes 514 which are spaced longitudinally along the crown/center line 504 of the floor 510. The exhaust pipes 514 have their lower end positioned in appropriately sized holes in the floor 510 and extend upwardly into the growth chamber 511. As such, the exhaust pipes provide additional venting between the floor plenum of the ventilated floor assembly 502 and the growth chamber and also allow air and humidity (moisture) which might collect underneath the crown of the floor 510 to escape into the growth chamber.

FIG. 40 illustrates yet another embodiment of a passive ventilated floor assembly in accordance with the present invention, generally designated by reference numeral 602, which is incorporated into a conventional chicken house, generally designated by reference numeral 600. The only difference between the FIG. 40 embodiment and the FIG. 39 embodiment is that the former includes exhaust fans, generally designated by reference numeral 614, spaced longitudinally along the crown/center line 604 of the ventilated floor 610 instead of the exhaust pipes 514. The major components of the embodiment shown in FIG. 40 utilize the same numbering system as the embodiment in FIG. 39, except the numbering system is in the 600 series, instead of the 500 series. The exhaust fans 614 provide for more positive withdrawal of the air and humidity (moisture) from the air plenum underneath the ventilated floor 610 than could be achieved utilizing only the passive exhaust pipes 514.

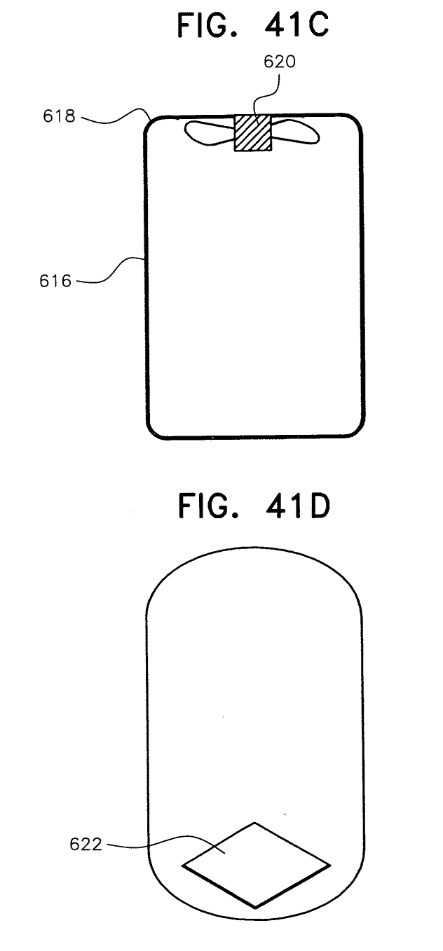

FIGS. 41A-D illustrate one embodiment of an exhaust fan structure which could be used in the passive system of FIG. 40 in accordance with the present invention. The exhaust fan 614 includes a vertically extending housing 616 which is preferably rounded inwardly as at 618 adjacent its upper end. Preferably positioned in the upper end of the housing 616 below the inward bend 618 is an exhaust fan 620 operated by a suitable electric motor or the like (not shown). The bottom of the housing 616 is placed over a suitable opening 622 formed in the floor 610 of the floor assembly 602, such as shown in FIGS. 41B and 41D.

As described herein, the passive embodiment of the present invention provides a very efficient structure for improving the air and footing conditions for the chicks and/or eliminating the need for blowers to force air through the ventilated floor. Instead, using only the existing fans already conventionally used in chicken houses to create tunnel ventilation air flow through the ends of the house, a natural air flow and negative pressure is generated in the floor plenum as well as the growth chamber through the plenum vents along the sides of the growth chamber and/or down a center line crown. This negative pressure evaporates the moisture content into the ventilation air flow (and out of the chicken house) to effectively dry the manure retained on the upper surface of the floor assembly to an ideal moisture content. This moisture content avoids dust formation while also preventing the formation of ammonia and methane gases so that odor in the chicken house is virtually eliminated. This improves both the quality of life for the chicks as well as the health of the livestock managers and the surrounding environs.

Another benefit of utilizing the present invention in existing chicken houses relates to the dust and other airborne contaminants usually encountered in chicken houses during the chicken growing cycle. Specifically, it has been surprisingly found during testing of the present invention that the dust and airborne contaminants usually encountered has been substantially reduced. As such, the present invention improves the health of the birds as they grow in the growth chamber and the atmospheric conditions encountered by workers in and around the growth chamber.

While the present invention has been described specifically for chicken houses and chicken growth or grow out facilities, those skilled in the art will recognize that the present invention may also be applicable to other fowl, including but not limited to quail, turkeys, duck, pullets and breeders.

Modifications and variations of the above-described structures and methods will undoubtedly occur to those of skill in the art. For example, multiple features are disclosed for the ventilated floor assembly of the present invention as included in the different embodiments, as well as different operating parameters for the active and passive embodiments. As understood by those skilled in the art, these features can be readily interchanged among the various embodiments without departing from the disclosed invention. It is therefore to be understood that the following claims define the scope of the invention and the invention may be practiced otherwise than is specifically described while falling within the scope of the claims.

What is claimed:

1. A fowl growing facility comprising a house having walls, a roof and a ventilated floor assembly with a ventilated floor and a ventilated bottom air plenum under said ventilated floor, an area above said floor and enclosed within said walls and roof defining a growth chamber for raising fowl therein, said house further including at least one air moving mechanism associated with said growth chamber and positioned above the floor for exhausting air out of the growth chamber into an outside environment through one or more exhaust vents in one or more of said walls to create a negative pressure inside the house, said ventilated floor having flow passages that are of a size to permit air and moisture to flow therethrough into the air plenum while retaining manure from said fowl on a top surface of said ventilated floor, said bottom air plenum being in air communication with said growth chamber through plenum vents to transmit said negative pressure in said growth chamber to said air plenum, said negative pressure causing moisture to evaporate from a bottom surface of the retained manure into the air of the air plenum through said floor flow passages and from a top surface of the retained manure into the air of the growth chamber to dry said manure retained on said floor to a desired moisture content and reduce ammonia production in the house.

2. The fowl growing facility as recited in claim 1, wherein the manure is dried to a moisture content of between about 20% and about 30% on a weight basis.

3. The fowl growing facility as recited in claim 1, wherein the dried manure has a pH less than 7.0, preferably between about 5.0 and about 6.0.

4. The fowl growing facility as recited in claim 1, wherein said fowl growing facility is an elongated chicken house with long side walls and short end walls, said at least one air moving mechanism is positioned in one of said end walls, and air inlet flaps or other negative pressure operated openings are positioned in said opposite end wall.

5. The fowl growing facility as recited in claim 4, wherein said at least one air moving mechanism and said air inlet flaps or other negative pressure operated openings create tunnel ventilation air flow through said chicken house which captures the moisture evaporated from said retained manure and sweeps the captured moisture from said growth facility and air plenum into the outside environment.

6. A fowl growing facility as recited in claim 1, further comprising a barrier sheet positioned underneath said ventilated floor assembly, said barrier sheet and said ventilated floor assembly insulating said growth chamber from a heat sink effect of ground of said house.

7. The fowl growing facility as recited in claim 1, wherein said plenum vents are located along one or more walls of said house.

8. A chicken growing facility comprising:
an enclosed growth chamber with one or more exhaust vents that allow air to flow between the growth chamber and the outside environment;
a ventilated floor assembly extending substantially completely under said growth chamber and having a floor and an air plenum underneath, said floor having flow passages that are of a size to permit air and moisture to flow from said growth chamber into said air plenum while retaining manure from chicks in said growth chamber on an upper surface thereof, said plenum being in air flow communication with said growth chamber through one or more plenum vents;
an exhaust fan associated with an upper area of said growth chamber for pulling air out of the growth chamber and into the outside environment through said exhaust vents and creating a negative pressure inside both the growth chamber and the air plenum;
said negative pressure evaporating moisture from a bottom surface of the retained manure into the air of the air plenum and from a top surface of the retained manure into the air of the growth chamber to dry manure retained on the floor to a moisture content of less than about 30% on a weight basis.

9. The chicken growing facility as recited in claim 8, wherein said floor has at least one crown extending longitudinally through said growth chamber generally in alignment with air flow therethrough, and floor portions on each side of the crown slope downwardly at an angle between about 1° to about 5°, preferably about 2°.

10. The chicken growing facility as recited in claim 9, wherein said plenum vents include exhaust pipes or exhaust fans positioned in appropriately sized holes in the floor at spaced locations along said crown.

11. A method for reducing ammonia in a fowl growth chamber including the steps of:
(a) providing a ventilated floor assembly in the fowl growth chamber including a ventilated floor for supporting the fowl and having a bottom plenum thereunder, said floor having flow passages of sufficient dimensions to permit flow of air and moisture through the floor while concurrently precluding passage of manure deposited on an upper surface of the floor into the plenum;
(b) placing one or more vents between the air plenum and the growth chamber to provide pressure equalization therebetween;
(c) creating a negative pressure inside the growth chamber and the air plenum by exhausting air out of the growth chamber into the outside environment; and
(d) evaporating moisture from the manure retained on the upper surface of the floor, both upwardly into said growth chamber and downwardly into said air plenum.

12. The method as recited in claim 11, wherein the manure is dried to a moisture content of between about 20% and about 30% on a weight basis.

13. The method as recited in claim 11, wherein the dried manure has a pH less than 7.0, preferably between about 5.0 and about 6.0.

14. A chicken house comprising
a pair of elongated side walls interconnected by a pair of end walls, a roof, and a ventilated floor assembly having a ventilated floor and a ventilated bottom air plenum under said ventilated floor;
a barrier sheet positioned underneath said ventilated bottom air plenum over ground of said chicken house, said barrier sheet and said ventilated floor assembly insulating said growth chamber from the ground of the chicken house;
said walls, roof, and floor defining a growth chamber for raising chicks therein;
said house further including at least one air moving fan positioned in one of said end walls and air inlet flaps or other negative pressure operating openings in said opposite end wall, said air moving fan and said air inlet flaps or other negative pressure operated openings creating negative pressure in said chicken house and tunnel ventilation air flow through said chicken house;
said ventilated floor having flow passages that are of a size to permit air and moisture flow therethrough into said air plenum while retaining manure from said chicks on a top surface of said ventilated floor;
said chicken house further including plenum vents which provide air communication between said growth chamber and said bottom air plenum to transmit negative pressure in said growth chamber to said air plenum; and
said negative pressure evaporating moisture from a bottom surface of the retained manure into the air of the air plenum and from a top surface of the retained manure into the air of the growth chamber to dry said manure retained on the floor to a desired moisture content and reduce ammonia production in the chicken house.

15. The chicken house as recited in claim 14, wherein the plenum vents are located along the elongated sides of the chicken house and/or through exhaust pipes or exhaust fans positioned generally vertically in the growth chamber and in communication with said bottom air plenum through openings in said ventilated floor.

16. The chicken house as recited in claim 14, wherein said ventilated floor has at least one crown extending through said growth chamber generally perpendicular to said end walls with said ventilated floor on opposite sides of said crown sloping downwardly away from said crown at an angle of between about 1° and about 5°, preferably about 2°, and wherein said plenum vents include one or more exhaust pipes or exhaust fans positioned at spaced locations along said crown.

17. The chicken house as recited in claim 14, wherein the ventilated floor underneath and around water dispensing nozzles in said growth chamber is provided with one or more layers of a polymer grid material to protect the feet of young chicks from the alkaline condition of the flooring underneath and around the water dispensers.

18. The chicken house as recited in claim 14, wherein said house is pre-existing and is retrofitted with said ventilated floor assembly, and said barrier sheet is positioned underneath said ventilated floor assembly over the ground or concrete flooring of the existing chicken house.

19. The chicken house as recited in claim 14, wherein said flow passages are in the shape of elongated slots.

20. The chicken house as recited in claim 19, wherein said flow passage slots are inwardly tapered both from a top surface of the ventilated floor and from a lower surface of the ventilated floor to provide a smaller slotted opening spaced between said top surface and said lower surface of said ventilated floor.

21. The chicken house as recited in claim 14, wherein said flow passages have a total area of openings between about 2% and about 25% of the total floor area, more preferably between about 3% and about 12% of the total floor area, and most preferably between about 4% and about 6% of the total floor area.

22. The chicken house as recited in claim 14, wherein said flow passages continue to permit moisture flow therethrough even though clogged with dry manure retained on said ventilated floor top surface.
